(19) United States
(12) Patent Application Publication
(10) Pub. No.: US 2017/0052036 A1
(43) Pub. Date: Feb. 23, 2017

(54) MOVEMENT GUIDANCE DEVICE AND MOVEMENT GUIDANCE METHOD

(71) Applicant: TOYOTA JIDOSHA KABUSHIKI KAISHA, Toyota-shi (JP)

(72) Inventor: Satoshi UNO, Tokyo (JP)

(73) Assignee: TOYOTA JIDOSHA KABUSHIKI KAISHA, Toyota-shi (JP)

(21) Appl. No.: 15/102,773

(22) PCT Filed: Dec. 8, 2014
(86) PCT No.: PCT/IB2014/002938

§ 371 Date: Jun. 8, 2016

(30) Foreign Application Priority Data
Dec. 9, 2013 (JP) 2013-253919

(51) Int. Cl. G01C 21/36; G01C 21/34

(52) U.S. Cl. CPC G01C 21/3694; G01C 21/3492

(57) ABSTRACT

A device includes a first unit that calculates a prediction error range of a predicted arrival time in a first route to a destination, a second unit that calculates a prediction error range of a predicted arrival time in a second route different from the first route at a point where the first route and the second route are branched, and an output unit that outputs at least one of the prediction error range of the first route or the prediction error range of the second route. At least one of the first unit or the second unit calculates the prediction error range based on information having correlation with the prediction error range at the point, and the output unit performs determination about the aspect of output of the prediction error ranges of the first route and the second route based on whether or not the prediction error range changes.

### BACKGROUND OF THE INVENTION

1. Field of the Invention

The present invention relates to a movement guidance device and a movement guidance method which perform guidance of movement to a destination.

2. Description of Related Art

In recent years, an information terminal, such as a navigation system for a vehicle, is provided with a function of guiding a route from a present place to a destination. This type of information terminal guides a driver with the route to the destination and with a predicted arrival time, which is the time at which the vehicle arrives at the destination or the time necessary until the arrival. The predicted arrival time calculated in an undifferentiated manner based on a traveling distance from a departure place to the destination changes every time depending on a road situation or the like, and thus there is often a difference between an actual arrival time and the predicted arrival time. Accordingly, for example, a device described in Japanese Patent Application Publication No. 2008-96445 (JP 2008-96445 A) is configured to calculate an error in predicted arrival time based on the degree of variation of traffic information for use in calculating the predicted arrival time. This device is configured to display the calculated error along with the predicted arrival time.

On the other hand, for example, if the predicted arrival time and a range of error of several minutes to tens of minutes before and after the predicted arrival time are guided, the driver has to recognize the predicted arrival time at a wide time width with an error. Then, for example, while the driver determines that the vehicle arrives at the earliest time out of the predicted arrival time with an error, when an actual arrival time is the latest time out of the predicted arrival time with an error, there is a significant difference between the predicted arrival time with an error expected by the driver and the actual arrival time. For this reason, even though an error in predicted arrival time is displayed, the driver will feel unease.

### SUMMARY OF THE INVENTION

The invention provides a movement guidance device and a movement guidance method capable of, in route guidance, increasing the suitability of output of a predicted arrival time or an arrival time with an error.

A movement guidance device according to a first aspect of the invention guides at least one of a predicted arrival time at which a mobile object arrives at a destination or a predicted movement time necessary until the mobile object arrives at the destination. The movement guidance device includes a first calculation unit which calculates at least one of a prediction error range of a predicted arrival time or a prediction error range of a predicted movement time in a first route to the destination, a second calculation unit which calculates at least one of a prediction error range of a predicted arrival time or a prediction error range of a predicted movement time in a second route, which is a route to the destination and is different from the first route, at a point where the first route and the second route are branched, and a predicted value output unit which outputs at least one of the prediction error range of the first route or the prediction error range of the second route. At least one of the first calculation unit or the second calculation unit calculates a prediction error range based on information having correlation with the prediction error range at the point where the first route and the second route are branched, and the predicted value output unit performs determination about the aspect of output of the prediction error range of the first route and the prediction error range of the second route based on whether or not the calculated prediction error range changes with respect to a reference prediction error range.

A movement guidance method according to a second aspect of the invention guides at least one of a predicted arrival time at which a mobile object arrives at a destination or a predicted movement time necessary until the mobile object arrives at the destination. The movement guidance method includes calculating at least one of a prediction error range of a predicted arrival time or a prediction error range of a predicted movement time in a first route to the destination, calculating at least one of a prediction error range of a predicted arrival time or a prediction error range of a predicted movement time in a second route, which is a route to the destination and is different from the first route, at a point where the first route and the second route are branched; and acquiring information having correlation with at least one of the prediction error range of the first route or the prediction error range of the second route at the point where the first route and the second route are branched and performing determination about the aspect of output of the prediction error range of the first route and the prediction error range of the second route based on whether or not the prediction error range changes based on the correlated information.

According to the above-described aspect, at a point where precision of a prediction error range is required, the prediction error range is calculated based on information having correlation with the prediction error range, and thus, calculation of the prediction error range is minimized. For this reason, a calculation load applied to the movement guidance device is reduced. When the prediction error range changes, each aspect of output of the prediction error range of the first route and the prediction error range of the second route is determined based on the changed prediction error range, and thus, it is possible to output the predicted arrival time or the predicted movement time with increased suitability.

As a preferred configuration, the predicted value output unit performs determination about whether or not the prediction error range of the first route changes based on information having correlation with the prediction error range of the first route when the prediction error range of the second route is smaller than the prediction error range of the first route and limits the output of information relating to the second route based on the degree of coincidence with a user's request estimated as the change direction of the prediction error range when the prediction error range of the first route changes.

According to the above-described configuration, when the degree of coincidence of the change direction of the prediction error range of the first route with the user's request is high, there is an increasing advantage in guiding the first route. For this reason, the output of information relating to the second route is limited, whereby it is possible to suppress the guidance of information having a low degree of coincidence with the user's request.

In the above-described aspect, after outputting the prediction error range of the first route in a first range, the predicted value output unit may acquire information capable of reducing the prediction error range as information having correlation with the prediction error range of the first route at the point where the first route and the second route are branched, and when the prediction error range is reduced, may output a prediction error range reduced smaller than the first range to an output device.

According to the above-described configuration, when the prediction error range of the first route is reduced, the prediction error range is output in the reduced state, and thus, it is possible to provide beneficial information to the user.

In the above-described aspect, the predicted value output unit may acquire collective intelligence data, in which the movement histories of a plurality of mobile objects are registered by feature quantity, as information having correlation with the prediction error range, may evaluate the degree of coincidence with a situation when outputting the collective intelligence data and the prediction error range, and may perform determination about whether or not the prediction error range changes based on the evaluated degree of coincidence.

According to the above-described configuration, determination is performed about whether or not the prediction error range changes based on the degree of coincidence of collective intelligence data and the current situation, and thus, improvement of precision of the prediction error range is expected.

In the above-described aspect, when the calculation of the prediction error range is performed based on the movement patterns of a plurality of kinds of mobile objects, and when the divergence between the movement pattern used for the calculation and the movement pattern of a mobile object to be an output target of a prediction error range is equal to or greater than a predetermined value, the predicted value output unit may limit the output of a prediction error range for which it is determined that the divergence is equal to or greater than the predetermined value.

When the movement patterns of a plurality of mobile objects used as so-called collective intelligence do not conform to the characteristic of the user, for example, the movement time, the arrival time, and the prediction error ranges of the movement time and the arrival time calculated based on the collective intelligence are highly likely to be different from the movement time or the arrival time by the user.

From this point, according to the above-described aspect, when the divergence between the movement pattern used for calculation and the movement pattern of the mobile object to be the output target of the prediction error range is equal to or greater than the predetermined value, the output of the prediction error range, for which it is determined that the divergence is equal to or greater than the predetermined value, is limited, whereby there is no case where information generated based on elements not conforming to the characteristic of the user is output. In other words, only information generated based on elements conforming to the characteristic of the user is provided to the user.

In the above-described aspect, the predicted value output unit may evaluate the degree of coincidence of the collective intelligence data and a current situation to be an output target of the prediction error range for at least one of a factor relating to the mobile object, a factor relating to the user of the mobile object, or a factor relating to the movement environment of the mobile object.

According to the above-described configuration, the characteristic relating to the user, the mobile object, or the movement environment is included, and thus, the provision of information conforming to the situation of the mobile object, the user, or the movement environment near a point where a first recommended route and a second recommended route are branched is performed.

In the above-described aspect, a predetermined point for use in the calculation of the prediction error range may be in terms of intersections or junctions, and the predicted value output unit may perform the output of the prediction error range each time the mobile object reaches near the predetermined point by a predetermined distance.

According to the above-described configuration, the prediction error range is calculated in terms of intersections or junctions, whereby it is possible to obtain the prediction error range relating to the up-to-date route according to the movement position of the mobile object. The prediction error range is calculated in terms of intersections or junctions, and thus, a load applied to the movement guidance device is reduced.

In the above-described aspect, when there are the first route set as a route to a destination and the second route different from the first route, the predicted value output unit may perform, as a prediction error range of the first route and a prediction error range of the second route, one of controls: a: control for performing “no” output when all prediction error ranges are equal to or greater than a preset range, b: control for performing the output of only the prediction error range of the first route when the prediction error range calculated for the first route is smaller than the prediction error range calculated for the second route, c: control for performing the output of only the prediction error range of the second route when the prediction error range calculated for the second route is smaller than the prediction error range calculated for the first route, and d: control for simultaneously performing the output of the prediction error range of the first route and the prediction error range of the second route when the prediction error range calculated for the second route is smaller than the prediction error range calculated for the first route.

In the pattern “a” of the above-described configuration, it is possible to suppress the guidance of unreliable information. In the pattern “b”, it is possible to guide only information of the first route with relatively high precision. In the pattern “c”, it is possible to guide only information of the second route with relatively high precision. In the pattern “d”, it is possible to guide information of the second route with relatively high precision while displaying the first route set in advance.

In the above-described aspect, when the latest predicted arrival time out of the prediction error range of the predicted arrival time is later than an arrival time intended by the user, the output relating to a route having the prediction error range may be inhibited.

In the above-described configuration, the guidance of a route in which there is a possibility of arriving later than the arrival time intended by the user is inhibited. For this reason, it is possible to increase the suitability of a route to be guided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the schematic configuration of an information terminal as a movement guidance device concerning a first embodiment of a movement guidance device and a movement guidance method according to the invention;

FIG. 2 is a diagram showing an example of an output aspect of a prediction error ranges of an arrival time of each of first and second recommended routes concerning the first embodiment;

FIGS. 3A and 3B are diagrams showing an output example (pattern 1) when the user expects early arrival at a destination and when the latest time of a prediction error range of an arrival time of a second recommended route is earlier than the earliest time of a prediction error range of an arrival time of a first recommended route, FIGS. 3C and 3D are diagrams showing an output example (pattern 2) when the user expects arrival within a predetermined range of a desired time and when the entire prediction error range of the arrival time of the second recommended route is included in the prediction error range of the arrival time of the first recommended route, and FIGS. 3E and 3F are diagrams showing an output example (pattern 3) when the user expects late arrival at the destination and when the earliest time of the prediction error range of the arrival time of the second recommended route is later than the latest time of the prediction error range of the arrival time of the first recommended route;

FIG. 4A is a diagram showing an arrival pattern in the pattern 1, and FIG. 4B is a diagram showing an example of an arrival pattern in the pattern 3;

FIGS. 5A and 5B are diagrams showing a comparative example to this embodiment of an arrival pattern in the pattern 2;

FIG. 6 is a flowchart showing an example of an output procedure of the prediction error range of the second recommended route of the first embodiment;

FIG. 7 is a flowchart showing an output procedure of a prediction error range in the pattern 2 in the flowchart shown in FIG. 6.

FIGS. 8A and 8B show a case where the prediction error range of the first recommended route changes, and specifically, FIG. 8A shows a state in which the prediction error range is enlarged, and FIG. 8B shows a state in which the prediction error range of the first recommended route is reduced and the output of the second recommended route is limited;

FIG. 9 is a diagram showing an example of a determination aspect of a second recommended route concerning a second embodiment of a movement guidance device and a movement guidance method according to the invention;

FIG. 10 is a diagram showing an example of a determination aspect of the degree of coincidence of collective intelligence data and personal data;

FIG. 11 is a diagram showing a search example of a route of the second embodiment;

FIG. 12 is a diagram showing an example of an analysis aspect of the degree of coincidence of collective intelligence data and personal data analyzed by factor;

FIG. 13 is a flowchart showing an output procedure of a prediction error range in the pattern 2 concerning third to ninth embodiments of a movement guidance device and a movement guidance method according to the invention;

FIG. 14 is a schematic view illustrating the relationship between a crossing pedestrian waiting density in the first recommended route and the prediction error range in the third embodiment;

FIG. 15 is a flowchart showing an output procedure of a prediction error range in the pattern 2 concerning a tenth embodiment of a movement guidance device and a movement guidance method according to the invention;

FIG. 16 is a flowchart showing an output procedure of a prediction error range in the pattern 2 concerning an eleventh embodiment of a movement guidance device and a movement guidance method according to the invention; and

FIG. 17 is a diagram showing an example of a movement guidance device and a movement guidance method connected to a center concerning another embodiment of a movement guidance device and a movement guidance method according to the invention.

### DETAILED DESCRIPTION OF EMBODIMENTS

### First Embodiment

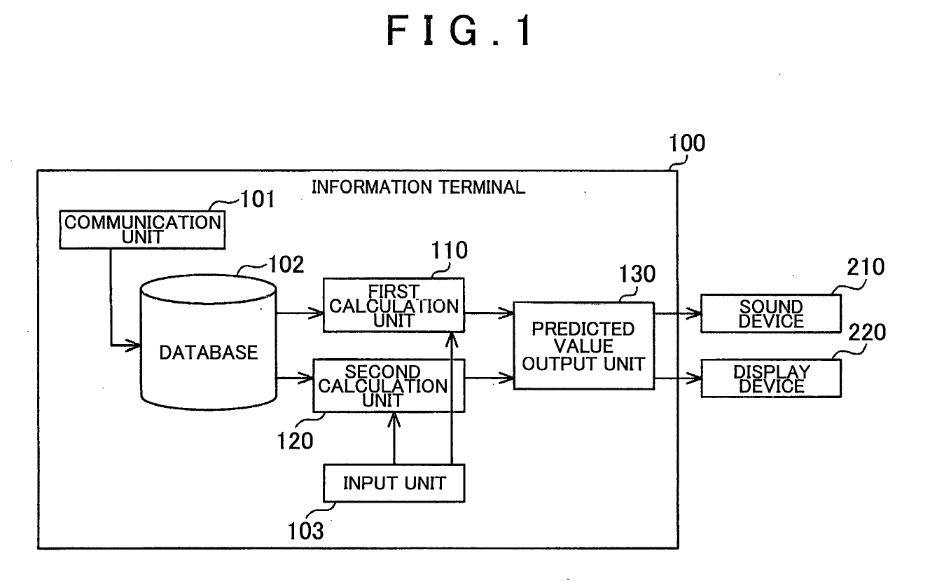

Hereinafter, a first embodiment which embodies a movement guidance device and a movement guidance method according to the invention will be described referring to FIGS. 1 to 8. The movement guidance device and the movement guidance method of this embodiment guide a route from a present place to a destination to a user who uses a vehicle. The destination includes a point in a certain movement route, a destination estimated in a previous movement history of the user, and the like, in addition to a destination set by the user.

Referring to FIG. 1, the schematic configuration of an information terminal to which the movement guidance device and the movement guidance method of this embodiment are applied will be described. An information terminal 100 of this embodiment has, for example, a navigation system which is used in a vehicle or a mobile information terminal, such as a smartphone, which is used in the vehicle. The information terminal 100 has a communication unit 101 which performs communication with a center or the like, which distributes road traffic information. The information terminal 100 has a database 102 in which information acquired from the outside by the communication unit 101 is registered.

For example, the communication unit 101 acquires traffic information, which is information necessary for calculating the movement time to the destination, from the center and outputs the acquired traffic information to the database 102. The traffic information includes, for example, link cost representing movement cost of each of links, which are sections in terms of intersections, traffic signals, junctions, or the like.

The information terminal 100 of this embodiment includes a first calculation unit 110, a second calculation unit 120, and a predicted value output unit 130. For example, if a destination of the user and a search condition are set through an input unit 103, such as a touch panel display, the first calculation unit 110 refers to link cost registered in the database 102. The first calculation unit 110 searches for a route to the destination based on the set condition using, for example, a Dijkstra method. The route searched at this time is based on link cost acquired from the center, and thus a traffic situation or the like when link cost is acquired is included. When a destination is not set, for example, the first calculation unit 110 estimates a destination based on histories of destinations previously set, a present movement route, a time zone, or the like.

The first calculation unit 110 calculates the range of a predicted movement time with an error or the range of a predicted arrival time with an error when using the searched route as a prediction error range based on link cost or the like. The searched route is as a first recommended route, and information representing the first recommended route and the prediction error range is output to the predicted value output unit 130.

The predicted value output unit 130 outputs the first recommended route and the prediction error range input from the first calculation unit 110 to at least one of a display device 220 as an output device and a sound device 210 as an output device.

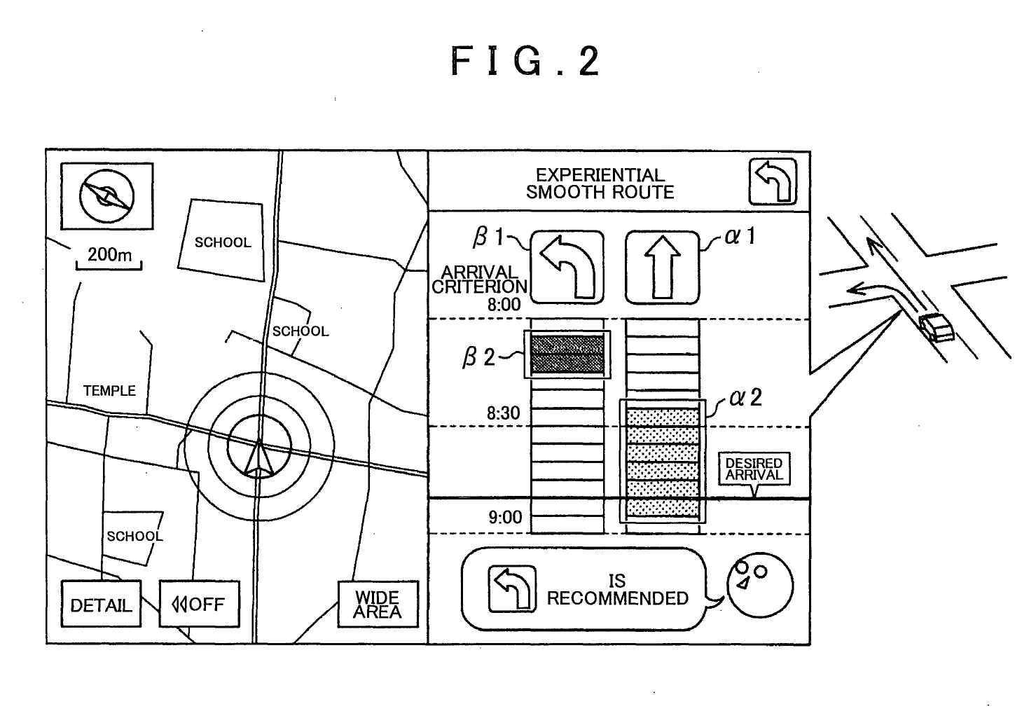

Referring to FIG. 2, an example of the guidance of the first recommended route and the prediction error range calculated by the first calculation unit 110 will be described. As shown in a region α1, for example, if a mobile object reaches a point near a certain intersection by a predetermined distance, the effect of passing straight through the intersection is displayed on the screen of the display device 220 as the guidance of a first recommended route when a destination is specified. As shown in a region α2 of FIG. 2, the range “08:25” to “08:55” of a predicted arrival time to the destination when the user continues to select the first recommended route, that is, when the mobile object passes straight through the intersection is displayed. The guidance of the first recommended route is based on a route guidance function which is normally performed.

In the example shown in FIG. 2, for example, the user sets “8:50” as a desired arrival time. The desired arrival time is set based on, for example, information registered in an application or the like to be used by the user, information registered by the user, the behavior pattern of the user, and the like.

For example, if the first recommended route is set and a vehicle, in which the information terminal 100 is used, starts to move, the second calculation unit 120 shown in FIG. 1 newly acquires traffic information through the communication unit 101 and the database 102 each time the vehicle arrives near an intersection or a junction by a predetermined distance. A route from the present place of the vehicle to the destination is searched based on link cost registered in the database 102, the acquired traffic information, and the like on a condition different from the search condition of the first calculation unit 110 using, for example, the Dijkstra method. When a destination is not set, or the like, the second route is searched based on histories of destinations previously set, a present movement route, a time zone, or the like from the estimated destination.

The second calculation unit 120 calculates a predicted arrival time and a predicted movement time when the searched route is used with the intersection, junction, or the like as a start point, and prediction error ranges which are errors of the predicted arrival time and the predicted movement time based on link cost, the acquired traffic information, and the like. The second calculation unit 120 outputs information of the route searched as a candidate of a second recommended route and the prediction error ranges to the predicted value output unit 130 at any time.

Next, the predicted value output unit 130 will be described. The predicted value output unit 130 has a function of estimating a user's request relating to an arrival time. The user's request is estimated based on schedule information of the user registered in the information terminal 100 or the like, the behavior pattern of the user, destination information, or the like. In this embodiment, when a desired arrival time is set and arrival by the desired arrival time is assumed, the user's request is dividedly determined into three of “arrival as early as possible”, “arrival neither too early nor too late”, and “arrival as late as possible”.

If the prediction error ranges are input from the first calculation unit 110 and the second calculation unit 120, the predicted value output unit 130 performs determination about whether or not the prediction error range calculated by the second calculation unit 120 is smaller than the prediction error range calculated by the first calculation unit 110. When the prediction error range calculated by the second calculation unit 120 is smaller than the prediction error range calculated by the first calculation unit 110, that is, when variation is small, the route calculated by the second calculation unit 120 is set as a second recommended route (smooth route). When it is assumed that there is a high advantage in guiding the second recommended route to the user, the second recommended route is guided to the user.

The predicted value output unit 130 performs determination about which of the following patterns 1 to 3 the relationship between the prediction error ranges corresponds to based on the prediction error ranges input from the first calculation unit 110 and the second calculation unit 120.

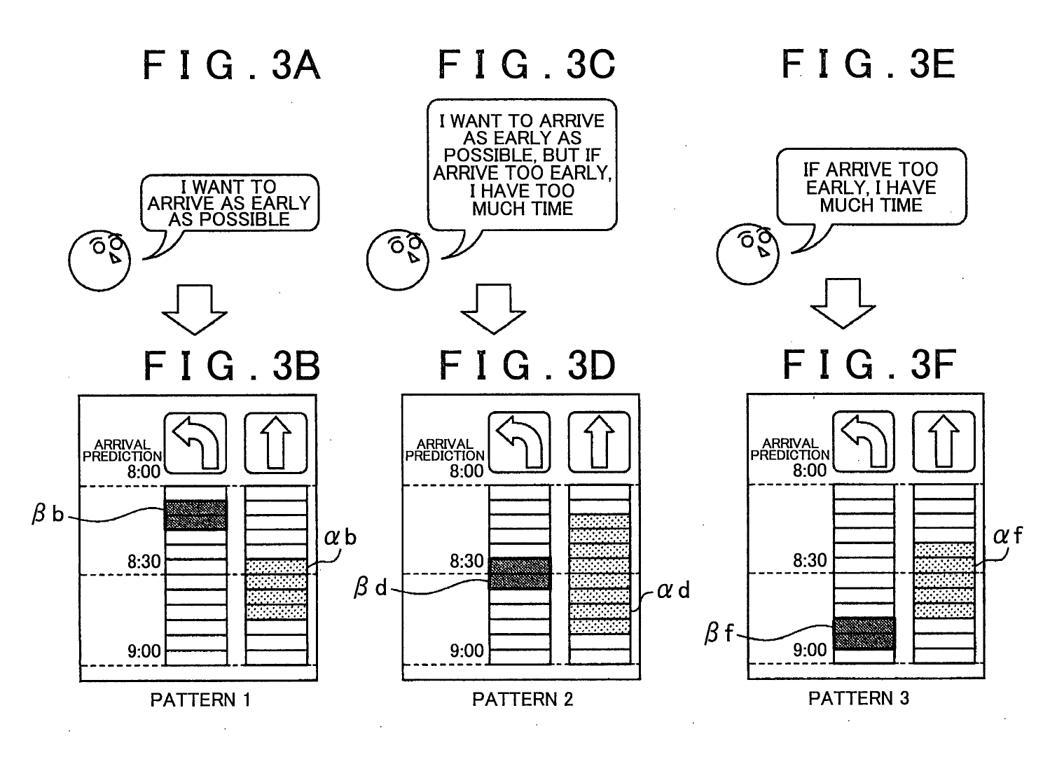

First, the pattern 1 will be described. As shown in a region βb of FIG. 3B, a case where any time in the prediction error range of the second recommended route is earlier than any time in the prediction error range of the first recommended route shown in a region αb is set as the pattern 1. As shown in FIG. 3A, when the user's request estimated by the predicted value output unit 130 is “arrive as early as possible”, it is desirable to guide a route having high probability capable of arriving at the destination early. Accordingly, there is an increasing advantage in guiding information relating to the second recommended route corresponding to the pattern 1 to the user.

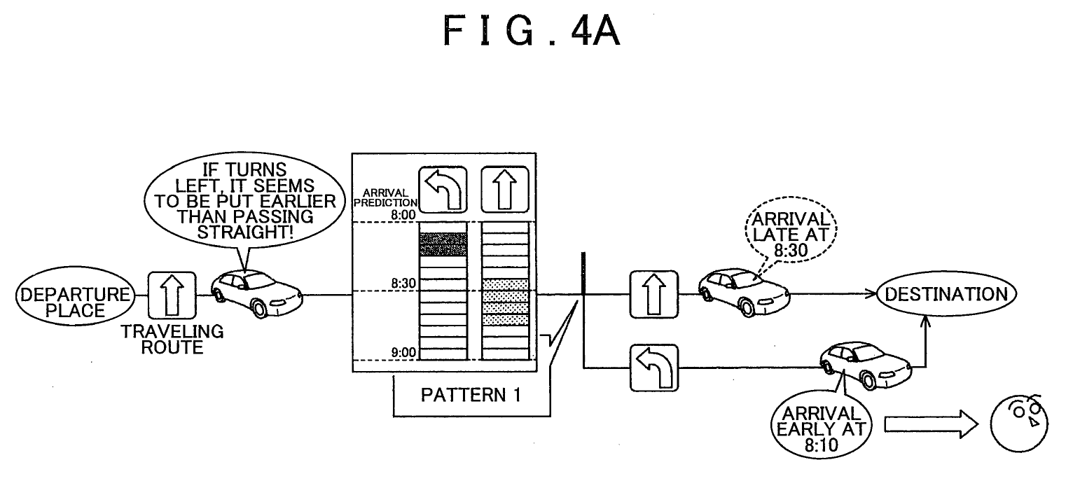

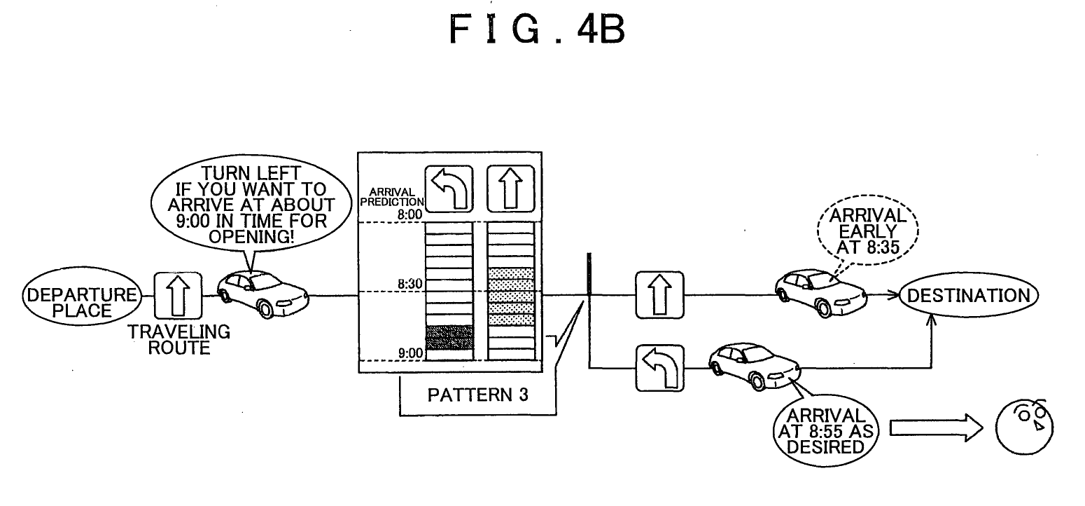

For this reason, as shown in FIG. 4A, when the user desires to arrive at the destination early, and any time in the prediction error range of the second recommended route is earlier than any time in the prediction error range of the first recommended route, information relating to the second recommended route is guided to the user. In this embodiment, as a display aspect of the screen of the display device 220, information relating to the second recommended route and information relating to the first recommended route are displayed simultaneously.

Referring to FIG. 2, an example of display when outputting the second recommended route will be described. For example, if the mobile object reaches a point near a certain intersection by a predetermined distance, the effect of turning left at the intersection to lead the user to the second recommended route is guided. In this embodiment, as shown in a region β2 of FIG. 2, the prediction error range “08:05” to “08:15” of a smooth route, which is the second recommended route branched from the middle of the first recommended route with variation smaller than the prediction error range of the first recommended route, is displayed.

Next, the pattern 3 will be described. As shown in a region βf of FIG. 3F, a case where any time in the prediction error range of the second recommended route is later than any time in the prediction error range of the first recommended route shown in a region αf is set as the pattern 3. As shown in FIG. 3E, when it is estimated by the predicted value output unit 130 that the user desires to arrive at the destination as late as possible, it is desirable to guide a route having high probability capable of arriving at the destination late. Accordingly, there is an increasing advantage in guiding information relating to the second recommended route corresponding to the pattern 3 to the user.

For this reason, as shown in FIG. 4B, when the user desires to arrive at the destination as later as possible, and any time in the prediction error range of the second recommended route is later than any time in the prediction error range of the first recommended route, information relating to the second recommended route is guided to the user. In this embodiment, information relating to the second recommended route and information relating to the first recommended route are displayed on the display screen of the display device 220 simultaneously.

Next, the pattern 2 will be described. As shown in a region βd of FIG. 3D, a case where the entire time in the prediction error range of the second recommended route is included in the prediction error range of the first recommended route shown in a region αd is set as the pattern 2. As shown in FIG. 3C, when it is estimated that the user desires to arrive neither too early nor too late, it is desirable to guide a route capable of arriving within a predetermined time from a desired arrival time, and there is an increasing advantage in guiding the second recommended route corresponding to the pattern 2. However, in case of the pattern 2, there are two opposing possibilities that the vehicle arrives at the destination earlier when using the first recommended route than when using the second recommended route and that the vehicle arrives at the destination later when using the first recommended route than when using the second recommended route. For this reason, in case of the pattern 2, it is not possible to determine an advantage in guiding the second recommended route only by simply comparing the prediction error ranges for a user who requests to “arrive as early as possible” and a user who requests to “arrive as late as possible”.

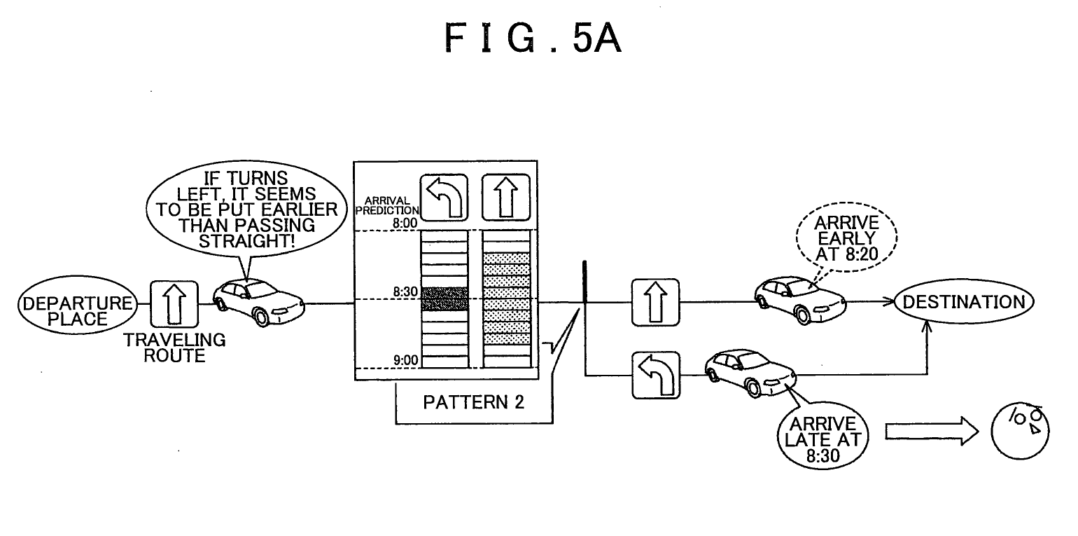

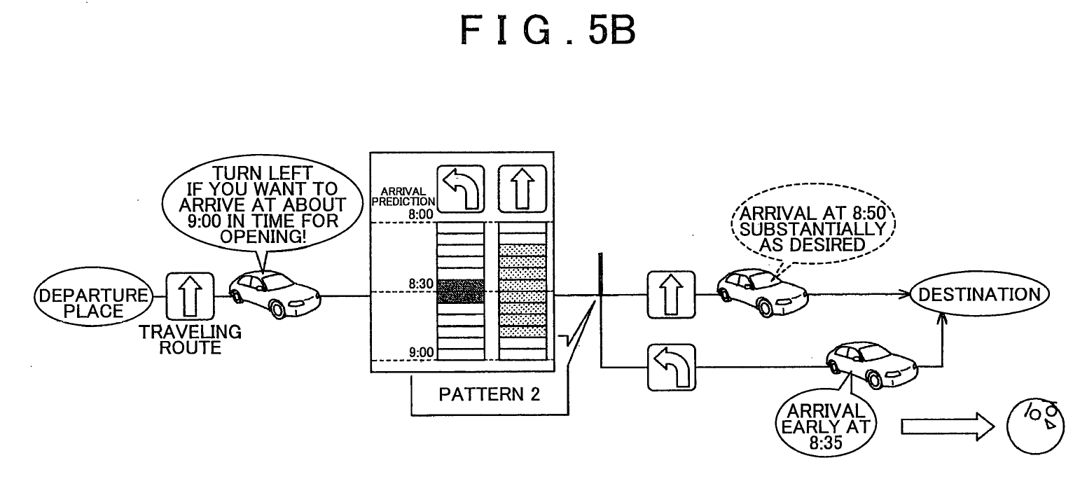

For this reason, as shown in FIG. 5A, while the second recommended route of the pattern 2 is guided to a user who actually expects early arrival at the destination, and the user selects the second recommended route having a predicted value “08:25” to “08:35” with relatively small variation, consequently, the user may arrive at the destination when using the first recommended route.

To the contrary, as shown in FIG. 5B, while the second recommended route of the pattern 2 is guided to a user who actually expects late arrival at the destination, and the user selects the second recommended route having a predicted value “08:25” to “08:35” with relatively small variation, consequently, the user may arrive late at the destination when using the first recommended route.

In this way, if information relating to the second recommended route is guided in a random manner even in the scene of the pattern 2, the user may select a route in which the movement time rarely varies, and it may be difficult to determine a route having a high degree of coincidence with the user's request.

Accordingly, in the movement guidance device and the movement guidance method of this embodiment, when the relationship between the prediction error range of the first recommended route and the prediction error range of the second recommended route corresponds to the pattern 1 and the pattern 3, and matches the user's request relating to the predicted arrival time, information relating to the first recommended route and the second recommended route is guided to the user. In case of the pattern 2, the permission/inhibition of the output of information relating to the second recommended route is determined based on whether or not the relationship matches the user's request, or whether or not the prediction error range of the first recommended route can change in the tendency desired by the user.

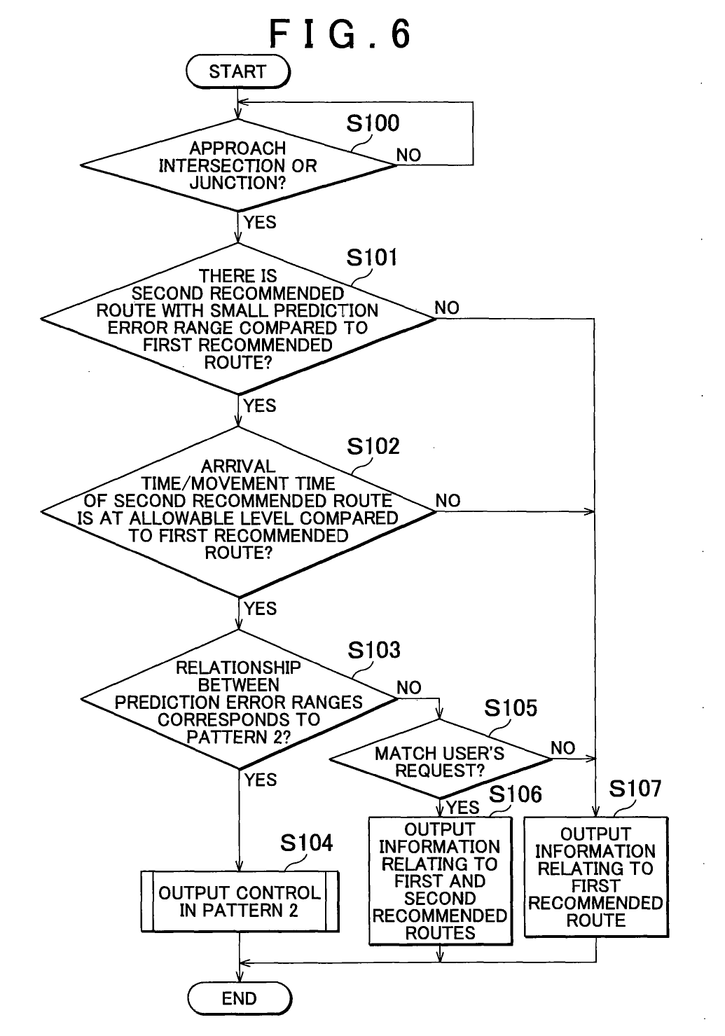

Next, the operation of the information terminal 100 will be described according to a processing procedure referring to FIG. 6. This processing is repeated in a predetermined cycle until a vehicle arrives at a destination. As shown in FIG. 6, for example, if a vehicle, in which the information terminal 100 is used, reaches near an intersection or a junction by a predetermined distance (Step S100: YES), the predicted arrival time or the predicted movement time relating to one to a plurality of second recommended routes is calculated. Then, determination is performed about whether or not there is a second recommended route having a prediction error range smaller than the first recommended route, in other words, small variation (Step S101). When there is no second recommended route with relatively small variation (Step S101: NO), only information relating to the first recommended route is output to at least one of the display device 220 and the sound device 210 (Step S107), and information relating to the second recommended route is not output. In this embodiment, in addition to the guidance of the first recommended route, the output of the prediction error range of the predicted arrival time is performed.

When there is a second recommended route with relatively small variation (Step S101: YES), determination is performed about whether or not the predicted arrival time or the predicted movement time of the second recommended route is at an allowable level compared to the first recommended route (Step S102). The determination about whether or not the predicted arrival time or the predicted movement time of the second recommended route is at an allowable level compared to the first recommended route is performed based on, for example, whether or not the difference from the predicted arrival time or the predicted movement time of the first recommended route is within a predetermined time, such as several minutes to tens of minutes. Alternatively, the determination may be performed based on whether or not the difference between the latest predicted arrival time of the second recommended route and a set desired arrival time is within a predetermined time, such as several minutes to tens of minutes.

In Step S102, if it is determined that predicted arrival time or the predicted movement time of the second recommended route is not at an allowable level (Step S102: NO), only information relating to the first recommended route is output (Step S107).

If it is determined that the predicted arrival time or the predicted movement time of the second recommended route is at an allowable level (Step S102: YES), determination is performed about whether or not the relationship between the prediction error range of the first recommended route and the respective prediction error ranges of the second recommended route corresponds to the pattern 2 (Step S103).

If it is determined that the relationship between the prediction error ranges corresponds to the pattern 2 (Step S103: YES), processing for output control in the pattern 2 is performed separately (Step S104).

In Step S103, If it is determined that the relationship between the prediction error ranges of the first and second recommended routes corresponds to the pattern 1 or the pattern 3 and does not correspond to the pattern 2 (Step S103: NO), determination is performed about whether or not the relationship between the prediction error ranges of the first and second recommended routes matches the user's request relating to the predicted arrival time (Step S105).

When the relationship between the prediction error ranges of the first and second recommended routes is the pattern 1, and when the estimated user's request is “arrival as early as possible”, it is determined that the relationship matches the user's request (Step S105: YES), and information relating to the first recommended route and information relating to the second recommended route are output (Step S106). In this embodiment, as in FIG. 2, in addition to the guidance of the first recommended route and the guidance of the second recommended route, the output of the prediction error range of the predicted arrival time of the first recommended route and the prediction error range of the predicted arrival time of the second recommended route is performed.

When the relationship between the prediction error ranges of the first and second recommended routes is the pattern 3, and when the estimated user's request is “arrival as late as possible”, it is determined that the relationship matches the user's request (Step S105: YES), and information relating to the first recommended route and information relating to the second recommended route are output (Step S106).

In Step S105, if it is determined that the relationship between the prediction error ranges of the first and second recommended routes does not match the user's request (Step S105: NO), only information relating to the first recommended route is output (Step S107).

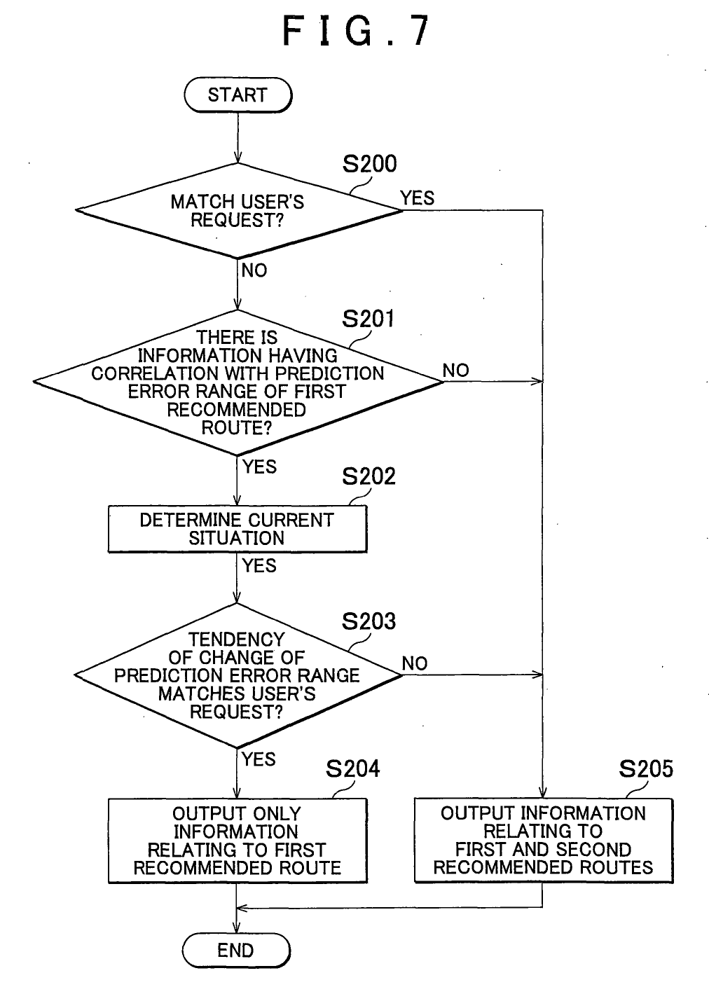

Next, output control processing (Step S104) when the relationship between the prediction error range of the first recommended route and the prediction error range of the second recommended route corresponds to the pattern 2 will be described referring to FIG. 7.

First, determination is performed about whether or not the second recommended route corresponding to the pattern 2 matches the user's request (Step S200). That is, when the relationship between the prediction error range of the first recommended route and the prediction error range of the second recommended route is the pattern 2, determination is performed about whether or not the user's request is “arrival neither too early nor too late”. If it is determined that the user's request is “arrival neither too early too late” (Step S200: YES), it is determined that the prediction error range of the second recommended route matches the user's request, and information relating to the first recommended route and information relating to the second recommended route are output (Step S205).

In Step S200, if it is determined that the user's request is other than “arrival neither too early nor too late” (Step S200: NO), determination is performed about whether or not there is information having correlation with the prediction error range of the first recommended route (Step S201). The correlated information is information relating to the first recommended route, and is, for example, history information based on the traveling histories of the host vehicle, history information regarding to traveling histories of other vehicles collected by the center, or the like. A factor for correlation with a prediction error range is not particularly limited. As an example, when congestion occurs in the first recommended route, and thus the degree of change in the movement time of the first recommended route is large, the distribution of the movement time is different on the condition of “congested” and “no congestion”. In this case, the history information is specified as “correlated information”. When history information which is information collected by an unspecified number of other vehicles and has the movement time distributed in the first recommended route for each vehicle manufacturer has no deviation according to the vehicle manufacturers, this information is specified as “uncorrelated information”.

If it is determined that there is no information having correlation with the prediction error range of the first recommended route (Step S201: NO), it is not possible to change the width of the prediction error range of the first recommended route, and thus, in this embodiment, information relating to the first recommended route and the second recommended route is output (Step S205). That is, in this case, the prediction error range of the first recommended route does not change in the tendency according to the user's request and does not change in the tendency against the user's request. It is difficult to say that one of the first recommended route and the second recommended route is highly likely to meet the user's request. Accordingly, in this embodiment, in order to allow the user to determine route selection based on the width of variation or the like, the second recommended route is guided in addition to the guidance of the first recommended route.

If it is determined that there is information having correlation with the prediction error range of the first recommended route (Step S201: YES), determination of a current situation is performed for a correlated factor (Step S202). Description will be provided in connection with the above-described example. In Step S201, when information representing the presence/absence of correlation of congestion and an arrival time or a movement time is specified as correlated information, traffic information is acquired, and determination is performed about whether or not congestion occurs in front of the traveling direction of the host vehicle on the first recommended route at this time.

In Step S202, if the current situation is determined for the correlated factor, determination is performed about whether the prediction error range of the first recommended route corresponds to a tendency to become early or a tendency to become late, and determination is performed about whether or not the tendency matches the user's request (Step S203). In the above-described example, when the prediction error range of the first recommended route is reduced in a direction where the latest time becomes early and has a tendency where the arrival time becomes early, and when the estimated user's request is “arrival as early as possible”, it is determined that the change tendency of the predicted arrival time matches the user's request. When the width of the prediction error range of the first recommended route is not changed and is deviated in a direction where the latest time becomes early, and when the estimated user's request is “arrival as early as possible”, it is determined that the change tendency of the predicted arrival time matches the user's request. When it is determined that the prediction error range of the first recommended route is reduced and has a tendency where the arrival time becomes early, and when the estimated user's request is “arrival as late as possible”, it is determined that the change tendency of the predicted arrival time does not match the user's request.

When the prediction error range of the first recommended route is enlarged or is deviated in a direction to become late, and changes in a direction where the latest time becomes late, and when the estimated user's request is “arrival as early as possible”, it is determined that the change tendency of the predicted arrival time does not match the user's request. When it is determined that the arrival time of the first recommended route has a tendency to become late due to congestion, and when the estimated user's request is “arrival as late as possible”, it is determined that the change tendency of the predicted arrival time matches the user's request.

At this time, determination about whether or not the change tendency of the predicted arrival time matches the user's request by comparison of a desired arrival time, such as “9:00”, and a prediction error range. For example, when the difference between the latest time of the prediction error range and the desired arrival time is small, and when it is determined that the arrival time of the first recommended route has a tendency to become late due to congestion, it may be determined that the change tendency of the predicted arrival time does not match the user's request. When the prediction error range of the first recommended route is shifted in a direction to become late, and the earliest time is later than the desired arrival time, it may be determined that the change tendency of the predicted arrival time does not match the user's request.

If the change tendency of the predicted arrival time does not match the user's request (Step S203: NO), the prediction error range of the first recommended route is recalculated; however, since the arrival time or the movement time is likely to change in a direction against the user's request, in addition to information relating to the first recommended route, information of the second recommended route is output (Step S205).

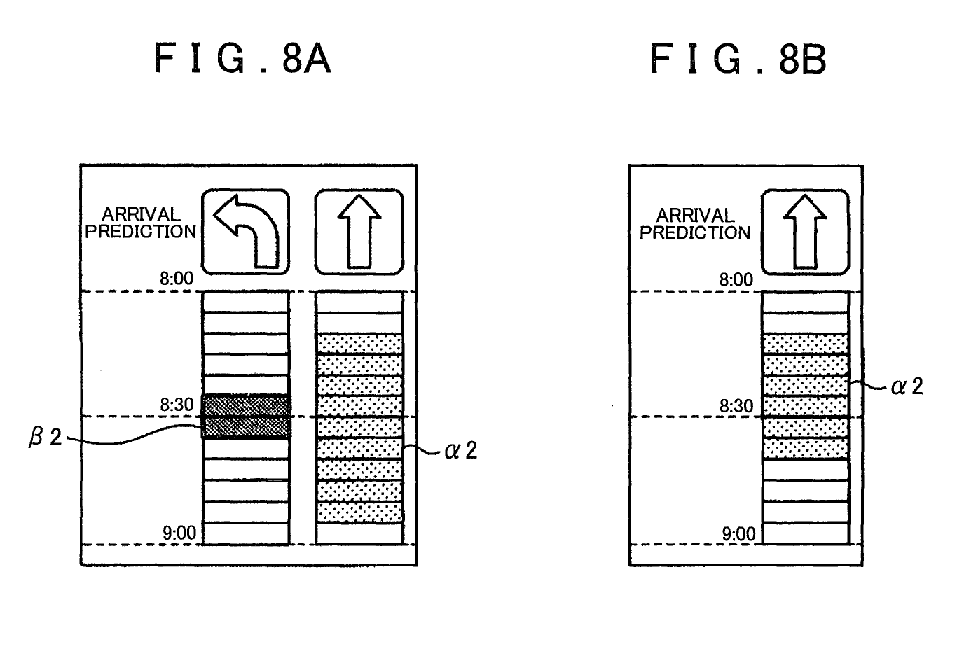

As shown in a region α2 of FIG. 8A, for example, when the user's request is “arrival as early as possible”, and the prediction error range of the first recommended route changes in a tendency to become late against the user's request, the range of the predicted arrival time is enlarged or is shifted and displayed in a direction against the user's request compared to the display width of the prediction error range of the first recommended route shown in FIG. 3D. If the first recommended route is selected, it may be notified that there is a possibility of becoming later.

If it is determined that the change tendency of the predicted arrival time matches the user's request (Step S203: YES), since precision of the prediction error range of the first recommended route is increased, and as a result, the arrival time or the movement time is likely to change in a direction according to the user's request, only information relating to the first recommended route is output (Step S204). For example, when congestion does not occur in the first recommended route, and the prediction error range is reduced and has a tendency where the latest time becomes early, there is an increasing advantage in guiding the first recommended route for a user who requests “arrival as early as possible”. For this reason, the second recommended route is not guided and only the first recommended route is output.

At this time, as shown in a region α2 of FIG. 8B, for example, the range of the predicted arrival time to the destination in the first recommended route is reduced compared to the display aspect of FIG. 3D. Alternatively, the range of the predicted arrival time is displayed in a state of being shifted in a direction according to the user's request. That is, in the pattern 2 where route selection is difficult compared to other patterns, the first recommended route having an increasing advantage of guidance is guided, and the second recommended route having a relatively little advantage is not guided. For this reason, the user easily selects a route having a high degree of coincidence with the user's request.

As described above, according to the movement guidance device and the movement guidance method of this embodiment, the following effects are obtained. (1) When determining the permission/inhibition of the output relating to the second recommended route corresponding to the pattern 2, the prediction error range is recalculated based on information having correlation with the prediction error range only at a point where the second recommended route is branched from the first recommended route and precision of the prediction error range of the first recommended route is required. For this reason, calculation of the prediction error range is minimized, and a calculation load applied to the information terminal 100 is reduced. When the prediction error range changes, the prediction error range is output to the display device 220 or the sound device 210 in the changed state. For example, when the prediction error range of the first recommended route is reduced, the prediction error range is output in the reduced state, and thus, it is possible to increase the suitability of the predicted arrival time or the predicted movement time output to the display device 220 or the sound device 210. For this reason, the user easily selects a route having a high degree of coincidence with the user's request.

(2) When determining the permission/inhibition of the output relating to the second recommended route corresponding to the pattern 2, determination is performed about whether or not the degree of coincidence of the change direction of the prediction error range of the first recommended route with the user's request is high. When the degree of coincidence with the user's request is high, there is an increasing advantage in guiding the first recommended route, and thus, the output of information relating to the second recommended route is limited. For this reason, it is possible to suppress the guidance of information having a low degree of coincidence with the user's request.

(3) When determining the permission/inhibition of the output relating to the second recommended route corresponding to the pattern 2, information capable of reducing the prediction error range of the first recommended route is reduced. When the prediction error range of the first recommended route can be reduced, that is, when variation in the predicted arrival time of the first recommended route is reduced, the prediction error range is output to the display device 220 or is output to the sound device 210 in the reduced state. For this reason, it is possible to provide beneficial information to the user.

(4) When determining the permission/inhibition of the output relating to the second recommended route corresponding to the pattern 2, the prediction error range of the first recommended route is calculated in terms of intersections or junctions. For this reason, it is possible to obtain the up-to-date prediction error range according to the movement position of the vehicle. Furthermore, the prediction error range of the first recommended route is calculated only at a point where the first recommended route and the second recommended route are branched, and thus a load applied to the information terminal 100 is reduced.

(5) When the prediction error range calculated for the second recommended route is smaller than the prediction error range calculated for the first recommended route, and when this relationship corresponds to the pattern 1 and the pattern 3, the second recommended route is guided along with the first recommended route. For this reason, the user can understand information relating to two recommended routes.

### Second Embodiment

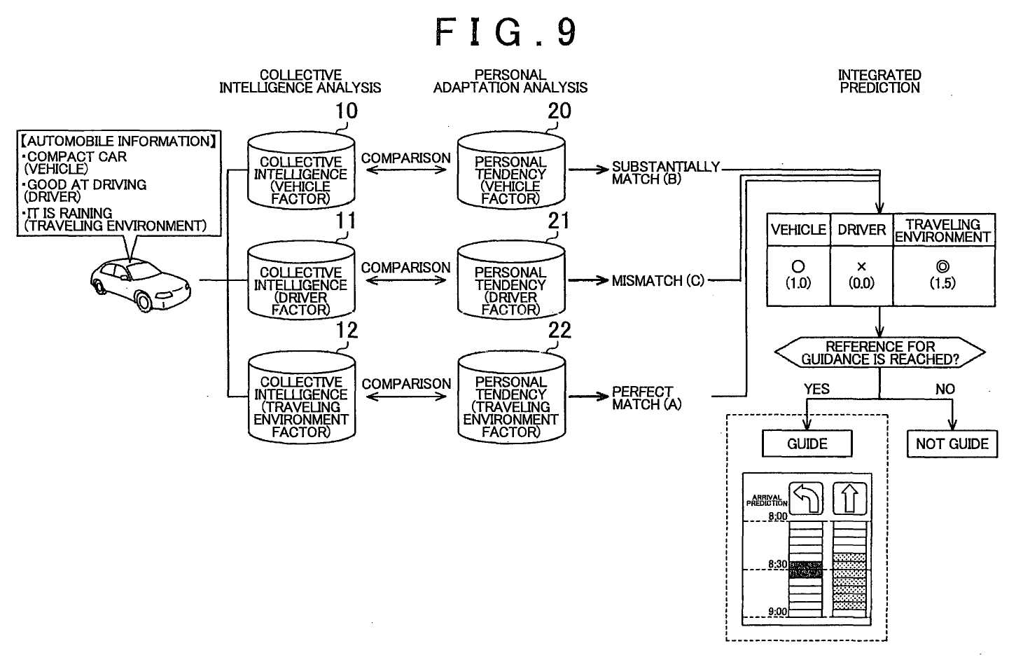

Next, a second embodiment of a movement guidance device and a movement guidance method according to the invention will be described referring to FIGS. 9 to 12 focusing on a difference from the first embodiment. The movement guidance device and the movement guidance method of this embodiment have the same basic configuration as in the first embodiment. In FIGS. 9 to 12, the substantially same elements as those in the first embodiment are represented by the same reference numerals, and overlapping description will be omitted.

The predicted value output unit 130 of this embodiment has a database for using the movement histories of a plurality of vehicles or the like as collective intelligence. When there is history information of the second recommended route among the routes registered in the database, the second calculation unit 120 of this embodiment calculates the movement time of the second recommended route, the arrival time, and the prediction error ranges of the movement time and the arrival time based on the movement time or the like on the route. For example, the database may be provided in a center which can perform communication with the communication unit 101 of the information terminal 100.

As shown in FIG. 9, the database has, as a database for collective intelligence collected from a plurality of vehicles, a database 10 in which information relating to the movement time on each route is registered by vehicle factor. The database further has a database 11 in which information relating to a plurality of movement times on each route is registered by user factor, and a database 12 in which information relating to a plurality of movement times on each route is registered by traveling environment factor of the vehicles.

In the database 10 for vehicle factors of collective intelligence, for example, a plurality of kinds of information relating to the movement times in terms of links are registered for each vehicle type. In the database 11 for user factors of collective intelligence, for example, user's skills are classified into three of “skill: high”, “skill: intermediate”, and “skill: low”, and a plurality of distributions of the movement times of the respective skills are registered in terms of links. In the database 12 for traveling environment factors of collective intelligence, for example, a plurality of kinds of information relating to the movement times by weather, the degree of congestion, area, time zone, or the like.

As shown in FIG. 9, the database further has, as a personal database collected from the information terminal 100, a database 20 in which information relating to a vehicle, in which the information terminal 100 is used, is registered, a database 21 in which information relating to the user of the vehicle is registered, and a database 22 in which information relating to the traveling environment of the vehicle is registered. As information relating to the vehicle, the type of vehicle in which the information terminal 100 is used is included, and the vehicle type information is registered in association with the distribution of the movement time of each route. As information relating to the user, for example, information representing a specified skill among “skill: high”, “skill: intermediate”, and “skill: low” is included, and the skill information is registered in association with the distribution of the movement time of each route. As information relating to the traveling environment of the vehicle, information, such as the distributions of the movement times of the respective routes classified by weather, the degree of congestion, area, time zone, or the like of the vehicle, in which the information terminal 100 is used, every time is registered.

Referring to FIG. 9, a method of analyzing the prediction error range of the second recommended route will be described. The predicted value output unit 130 compares personal data of the personal databases 20 to 22 with collective intelligence data registered in the databases 10 to 12 as collective intelligence for the movement time of the second recommended route by vehicle factor, user factor (driver factor), and traveling environment factor. The predicted value output unit 130 obtains the degree of coincidence of the movement time distribution and the distribution of the movement time of personal data from the comparison result.

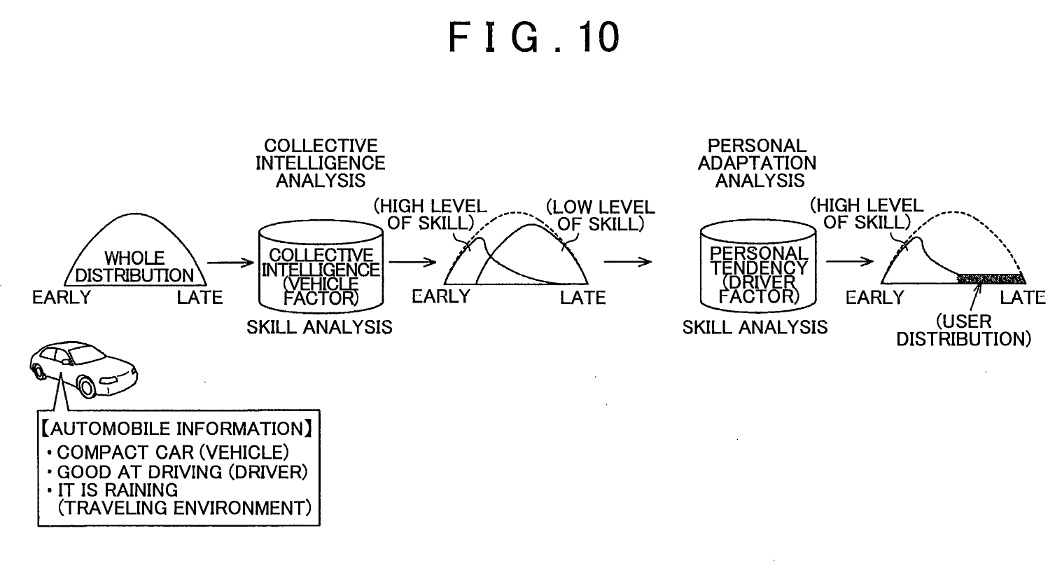

FIG. 10 shows an example of a comparison aspect of collective intelligence data and personal data of the user. As shown in FIG. 10, for example, a comparison target is the driving skill of the user, collective intelligence data is analyzed, and when the driving skill is high, it is determined that it is possible to arrive at the destination relatively early. Next, even if it is determined that the driving skill of the user is “high”, when the driving tendency of the user, that is, the distribution of the movement time based on the traveling history of the vehicle driven by the user is different from the distribution of collective intelligence data of the driving skill “high”, collective intelligence data does not conform to the driving tendency of the user. Accordingly, at this time, for example, even though the driving skill conforms, there is a higher probability that the arrival time or the movement time calculated based on collective intelligence data does not conform to the arrival time or the movement time desired by the user. For this reason, in regards to the driver factor of “driving skill”, it is determined that the degree of coincidence of the distributions is low.

As shown in FIG. 9, the predicted value output unit 130 multiplies a predetermined coefficient according to the degree of coincidence, and calculates, for example, the degree of coincidence “1.0” of the vehicle factor, the degree of coincidence “0.0” of the user factor, and the degree of coincidence “1.5” of the traveling environment. Then, the predicted value output unit 130 performs determination about whether or not the total value “2.5” of the calculated degrees of coincidence reaches a predetermined reference value.

The predicted value output unit 130 determines that information relating to the second recommended route calculated by the second calculation unit 120 is able to be output only when it is determined that the total value of the respective degrees of coincidence reaches a predetermined reference value. That is, the prediction error range of the second recommended route is calculated based on general information, such as traffic information or the traveling histories of other vehicles, and a personal tendency is not reflected therein. Accordingly, when there is large divergence between collective intelligence data and personal data, the prediction error range of the second recommended route does not necessarily conform to the arrival time when the user selects the second recommended route. For this reason, when it is determined that the total value of the respective degrees of coincidence reaches the predetermined reference value, the movement time of the second recommended route conforms to the user, and it is determined that information relating to the second recommended route calculated by the second calculation unit 120 is able to be output.

In this embodiment, when it is determined that information relating to the second recommended route is able to be output, and when the relationship between the prediction error range of the first recommended route and the prediction error range of the second recommended route corresponds to the pattern 2 described in the first embodiment, the predicted value output unit 130 verifies the prediction error range of the first recommended route using collective intelligence data and personal data. When it is determined that information relating to the second recommended route is able to be output, and when the relationship between the prediction error range of the first recommended route and the prediction error range of the second recommended route corresponds to the pattern 1 or the pattern 3 described in the first embodiment, the predicted value output unit 130 does not verify the prediction error range of the first recommended route using collective intelligence data and personal data.

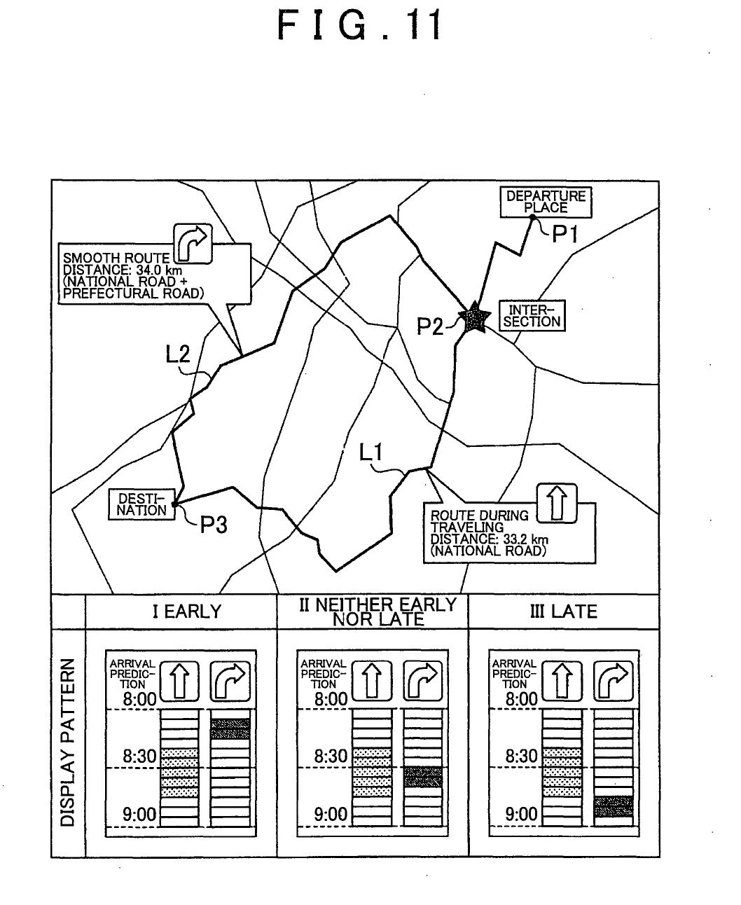

As shown in FIG. 11, for example, it is assumed that a user with a low level of driving skill drives a heavy vehicle from a departure place P1 toward a destination P3 on a rainy condition at night on a weekday. For example, if the vehicle reaches a point near an intersection P2 by a predetermined distance, when there is a second recommended route L2 (smooth route) which is a route different from a first recommended route L1 hitherto guided and branched from the intersection P2, the predicted value output unit 130 verifies the prediction error range of the first recommended route, thereby determining the permission/inhibition of the output of guidance of the second recommended route.

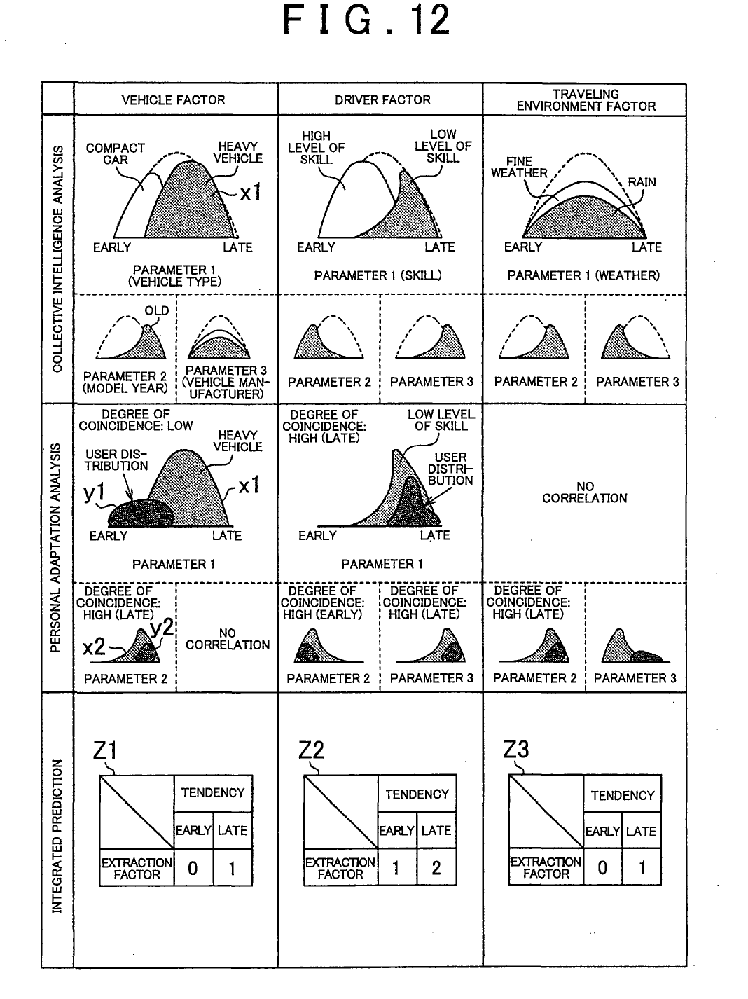

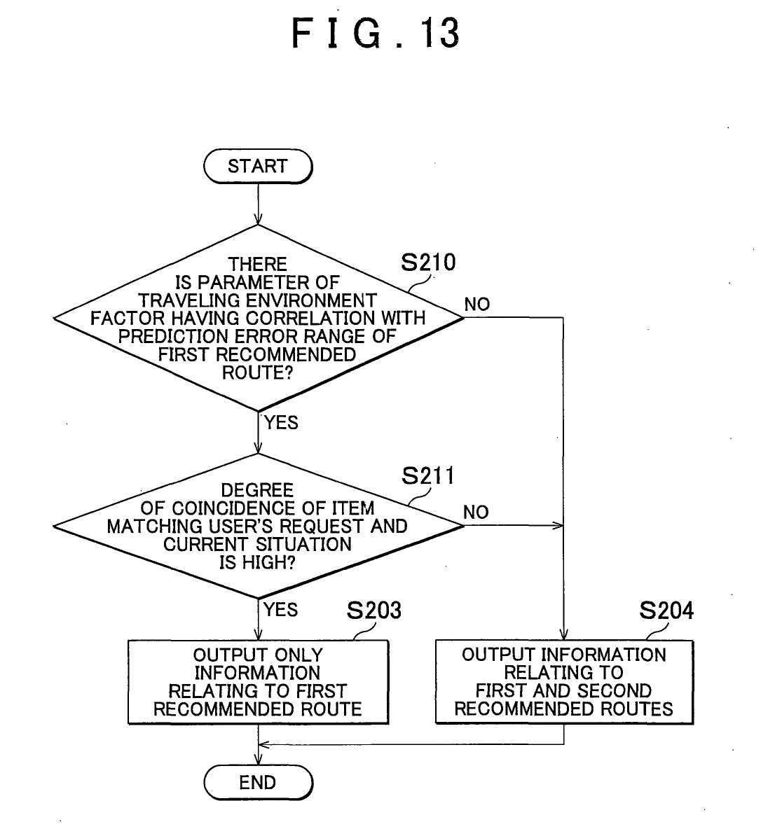

As shown in FIG. 12, in this embodiment, during the determination, since variation of the arrival time (movement time) in the first recommended route L1 is wide, analysis is further performed in order to recognize whether arrival tends to be early or late. In this analysis, collective intelligence analysis, personal adaptation analysis which is analysis of the characteristic of the user, to which a service is provided, and integrated prediction which is integrated analysis based on collective intelligence analysis and personal adaption analysis are performed.

In the collective intelligence analysis, a factor which has an influence on the predicted arrival time and the predicted movement time is specified by vehicle factor, user factor, and traveling environment factor for the first recommended route. Each factor is further divided into a plurality of parameters (parameter 1, parameter 2, . . . ). In an example of FIG. 12, “vehicle type” which is a parameter 1 among the vehicle factors and “skill” which is a parameter 1 among the user factors have a relatively large influence on “early” and “later” of the predicted arrival time. The influence of weather among the traveling environment factors is relatively small.

In detail, in the collective intelligence analysis for “vehicle type” which is the parameter 1 relating to the vehicle factors, a heavy vehicle has a tendency that the arrival time becomes relatively late. To the contrary, a compact car has a tendency that the arrival time becomes relatively early. For example, according to “model year” of the vehicle defined as a parameter 2 relating to the vehicle factors, there is a tendency that, when the model year is old, the arrival time becomes relatively late and the movement time becomes relatively long. In the drawing, only the distribution of a vehicle whose model year is old is shown.

According to “vehicle manufacturer” defined as a parameter 3 relating to the vehicle factors, even if the manufacturers are different, there is no influence on “early” and “late” of the arrival time, and there is no correlation (no correlation). In the example of the collective intelligence analysis, the parameters 1 and 2 among the vehicle factors are selected as a comparison target with information having correlation with the prediction error range of the first recommended route, that is, the characteristic of the user.

In the user characteristic analysis (personal adaptation analysis), if it is assumed that a vehicle which is used by the user is a heavy vehicle and has a characteristic represented as a distribution y1, the distribution y1 is compared with a general distribution x1 of a heavy vehicle represented by collective intelligence data. However, in this example, the distribution y1 of the user is diverged from the distribution x1 represented by collective intelligence data, and it is determined that the degree of coincidence of the distributions is “low”. For this reason, in the determination of the prediction error range of the arrival time (predicted movement time) or the movement time (predicted movement time), the parameter 1 relating to the vehicle factors is excluded from an analysis target as information having no correlation with the prediction error range of the first recommended route.

To the contrary, in regards to “model year” which is the parameter 2 relating to the vehicle factors, the tendency of a distribution x2 of collective intelligence data equivalent to “model year” of the host vehicle is similar to the tendency of a distribution y2 of “model year” of the host vehicle. For this reason, the degree of coincidence of the characteristic of collective intelligence data and the characteristic of the user is high, and in the guidance of the arrival time or the movement time to the user, analysis using data relating to the parameter 2 among collective data of the vehicle factors is valid. In this way, a factor having a high degree of coincidence is determined through the collective intelligence analysis and the personal adaptation analysis, and in regards to the factor, determination is performed about whether or not there is a tendency that the predicted arrival time of the user is early or becomes late. In regards to a factor having a high degree of coincidence, when there is a tendency that the predicted arrival time becomes early, a predetermined value (for example, “1”, “0.5”) is added to the total value of “a tendency to become early”. When there is a tendency that the predicted arrival time becomes late, a predetermined value is added to the total value of “a tendency to become late”. After all factors are verified, the total value of “a tendency to become early” and the total value of “a tendency to become late” are compared. As shown as Table z1 in FIG. 12, there is a high possibility that the arrival time calculated from collective intelligence data based on the vehicle factors is relatively late compared to an average value, and the movement time is required to be relatively long.

In FIG. 12, a result obtained from the degree of coincidence with the respective parameters 1 to 3 of the driver factors is shown as Table z2. As shown in the drawing, it is predicted that the arrival time which is predicted according to collective intelligence data based on the driver factors and the user characteristic becomes relatively late.

In FIG. 12, a result obtained from the degree of coincidence of the respective parameters 1 to 3 of the traveling environment factors is shown as Table z3. As shown in the drawing, it is predicted that the arrival time which is predicted according to collective intelligence data based on the traveling environment factors and the user characteristic is relatively late.

Through the analysis of the vehicle factors, the driver factors, and the traveling environment factors, if the total value of relatively “early” and “late” of the arrival time obtained by factor is totaled, in the example of FIG. 12, “early: 1” and “late: 4” are set, and the arrival time of the first recommended route has a relatively increasing tendency to become late.

Accordingly, in Step S203 (see FIG. 7), for example, when the user desires to arrive at the destination as early as possible, since it is predicted through the above-described analysis that the first recommended route becomes late, the predicted value output unit 130 determines that the change tendency of the prediction error range does not conform to the user's request (Step S203: NO). The predicted value output unit 130 outputs information relating to the calculated arrival time (predicted arrival time) or the movement time (predicted movement time) of the second recommended route in addition to information of the first recommended route (Step S205). As described above, the output second recommended route is a route where the degree of coincidence of collective intelligence data and personal data reaches a reference, that is, a route where the results of the collective intelligence analysis and the personal adaptation analysis match each other, and is determined to be able to output based on whether or not the router meets the user's desire.

With this, the permission/inhibition of the output of information relating to the second recommended route is determined based on the tendency of the user, a factor having an influence on the arrival time, or the like while calculating the arrival time or the movement time using collective intelligence data based on information of an unspecified number of users, and the determination of the permission/inhibition of the output conforms to the characteristic of the user. That is, it is expected that the necessity of the output of information relating to the second recommended route further conforms to the desire of the user.

When the user at the departure place P1 desires to late arrival at the destination P3, for example, the presence/absence of the second recommended route according to the desire of the user near the intersection P2 in the middle of the first recommended route by a predetermined distance is determined. In the determination, similarly to the above-described method, the tendency of lateness or earliness of the arrival time or the tendency of the length of the movement time for the first recommended route having large variation of the arrival time (movement time) is determined based on the degree of coincidence of the characteristic of collective intelligence data and the characteristic of the user and the correlation between each parameter and the arrival time or the movement time. In this example, when the user selects the first recommended route, if there is a tendency that the arrival time becomes relatively late, the first recommended route matches the user's request desires late arrival at the destination (Step S203 of FIG. 7: YES). For this reason, even if there is the second recommended route which is branched from the intersection P2, the output of information relating to the second recommended route is not performed. That is, the output of information relating to the second recommended route is limited, and the output of only information relating to the first recommended route is performed.

As described above, according to the movement guidance device and the movement guidance method of this embodiment, the effects of (1) to (5) are obtained, and the following effects are also obtained.

(6) When determining the permission/inhibition of the output relating to the second recommended route corresponding to the pattern 2, a database in which collective intelligence data is registered is used when calculating the prediction error range of the first recommended route. For this reason, the prediction error range of the first recommended route is calculated with the movement time of the vehicle which travels on an actual road, or the like, instead of traffic information calculated in an undifferentiated manner by a road traffic information center or the like. For this reason, improvement of precision of the prediction error range is expected. Determination about whether or not the prediction error range changes is performed based on the degree of coincidence of collective intelligence data relating to the first recommended route and the situation of the user (host vehicle). The situation of the user (host vehicle) when calculating the prediction error range is included, and thus, the provision of information conforming to the situation at this time is performed.

(7) The parameters relating to the vehicle factors, the driver factors, and the traveling environment factors are used when calculating the prediction error range of the first recommended route. For this reason, the provision of information conforming to the situation of the user (host vehicle) at this time is performed. In regards to a parameter having a high degree of coincidence with the situation of the user in each factor, the degree of coincidence is added to “early” and “late” of the arrival time, whereby the degree of coincidence with the situation of the user is evaluated. For this reason, it is possible to increase precision of the prediction error range.

### Third Embodiment

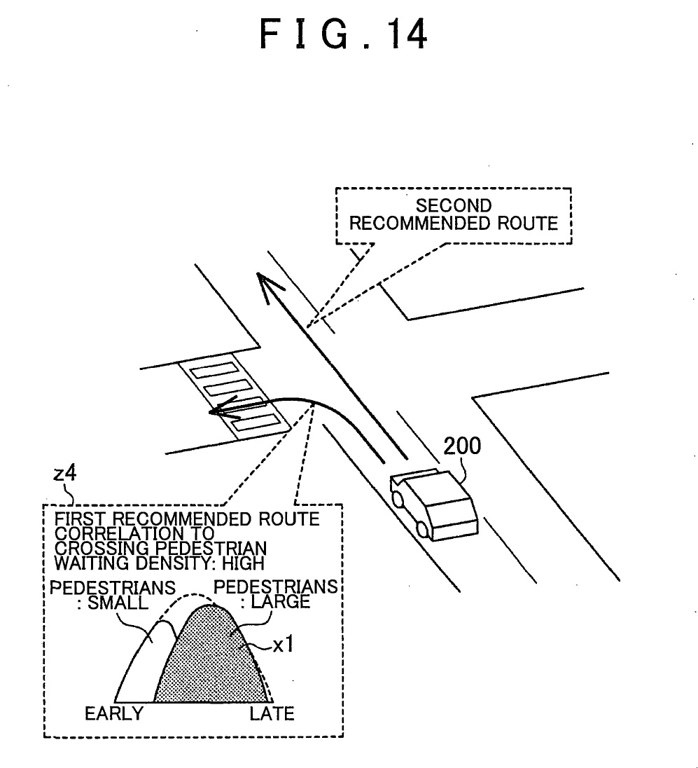

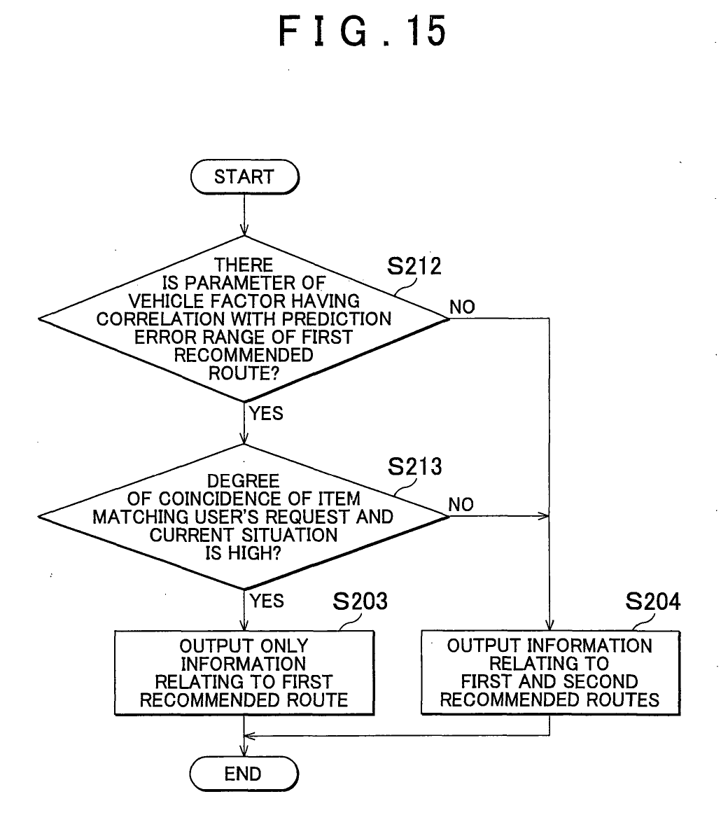

Next, a third embodiment of a movement guidance device and a movement guidance method according to the invention will be described referring to FIGS. 13 and 14 focusing on a difference from the first embodiment. The movement guidance device and the movement guidance method of this embodiment have the same basic configuration as in the first embodiment. In FIGS. 13 and 14, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, information relating to the traveling environment factors is used as information for determining the presence/absence of change in the prediction error range of the first recommended route. Referring to FIG. 13, output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the traveling environment factors based on collective intelligence data registered in the database of the predicted value output unit 130. In this embodiment, determination is performed about whether or not there is correlation with a parameter of crossing pedestrian wafting density.

As shown in FIG. 14, for example, when the first recommended route is left turn at an intersection in front of the traveling direction, and there is a crosswalk in a left-turn direction, the left-turn waiting time of the vehicle changes according to the number of pedestrians passing through the crosswalk. That is, even if the density of the crossing pedestrians who wait before the crosswalk is large, the traffic signal at the intersection displays permission of traveling of the vehicle 200, since there are many vehicles which wait for left turn, the vehicle 200 cannot turn left smoothly. When the density of crossing pedestrians who wait before the crosswalk is small, the vehicle 200 can often turn left smoothly. Accordingly, in this case, it can be said that the arrival time or the movement time of the first recommended route has high correlation with the crossing pedestrian waiting density.

For example, as shown in a region z4 of FIG. 14, the predicted value output unit 130 acquires information representing the distribution of the movement time when the crossing pedestrian waiting density at the intersection of the first recommended route is large (“crossing pedestrians: large”) and the distribution of the movement time when the crossing pedestrian waiting density is small (“pedestrians: small”) out of collective intelligence data registered in the database 102. Determination is performed about whether or not there is correlation between the magnitude of the crossing pedestrian waiting density and the arrival time of the first recommended route. In this example, it is determined that the magnitude of the crossing pedestrian waiting density and the arrival time of the first recommended route have high correlation (have correlation).

In Step S210 shown in FIG. 13, if it is determined that the prediction error range of the first recommended route has correlation with the crossing pedestrian waiting density at the intersection (Step S210: YES), determination is performed about whether or not the degree of coincidence of an item matching the user's request relating to the arrival time to the destination among the parameters of the crossing pedestrian waiting density and a current situation is high (Step S211). That is, since “item” according to the user's request “arrival as early as possible” is “crossing pedestrian waiting density: small”, determination is performed about whether or not the actual crossing pedestrian waiting density at the intersection is small. Determination about whether or not the crossing pedestrian waiting density is small is performed based on information received from the center, information received from a device provided near the intersection by road-to-vehicle communication, information received by vehicle-to-vehicle communication, or the like through the communication unit 101.

When it is determined that the crossing pedestrian waiting density is small (Step S211: YES), only information relating to the first recommended route is output (Step S203). That is, when the crossing pedestrian waiting density is small, there is a high possibility that the vehicle can pass through the crosswalk smoothly. When the prediction error range of the first recommended route includes lateness of the arrival time by the crossing pedestrian waiting density as an error in advance, the prediction error range is reduced. Accordingly, since there is a relatively increasing advantage in guiding the first recommended route, the output of the second recommended route is limited.

In Step S210, when it is determined that the arrival time or the movement time of the first recommended route has no correlation with the crossing pedestrian waiting density (Step S210: NO), in this embodiment, information relating to the first recommended route and the second recommended route is output (Step S204).

In Step S211, when it is determined that the actual crossing pedestrian waiting density at the intersection is large (Step S211: NO), information relating to the first recommended route and the second recommended route is output (Step S204). That is, since there is a possibility that the prediction error range of the first recommended route is enlarged or is shifted in a direction to become late to the whole, there is a relatively increasing advantage in guiding the second recommended route. For this reason, information relating to the second recommended route is output along with the first recommended route.

As described above, according to the movement guidance device and the movement guidance method of this embodiment, the effects of (1) to (6) are obtained, and the following effects are also obtained.

(8) The crossing pedestrian waiting density at the intersection on the first recommended route which is a parameter relating to the traveling environment factors is used when calculating the prediction error range of the first recommended route. For this reason, the provision of information conforming to the situation of the traveling environment around the host vehicle is performed at a point where the first recommended route and the second recommended route are branched.

### Fourth Embodiment

Next, a fourth embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, a traffic situation which is one of the traveling environment factors is used as information (parameter) for performing determination about the presence/absence of change in the prediction error range of the first recommended route. The traffic situation is congestion on a route, traffic regulation, or the like. For example, if congestion occurs in the first recommended route, the arrival time of the first recommended route becomes late. For example, when the number of passable lanes changes according to a time zone, the arrival time of the first recommended route becomes late in the time zone.

Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the traffic situation, which is a parameter relating to the traveling environment factors, based on collective intelligence data registered in the database of the predicted value output unit 130.

If it is determined that the prediction error range of the first recommended route, that is, the arrival time to the destination has no correlation with the traffic situation (Step S210: NO), information relating to the first recommended route and the second recommended route is output (Step S204).

In Step S210, if it is determined that the arrival time of the first recommended route has correlation with the traffic situation (Step S210: YES), determination is performed about whether or not the degree of coincidence of an item matching the user's request among the parameters of the traffic situation and a current situation is high (Step S211). That is, determination is performed about whether or not the traffic situation in front of the traveling direction of the host vehicle on the first recommended route is an item, such as “no congestion” or “no traffic regulation”. The traffic situation in front of the host vehicle is determined based on information received from the center, information received from a device provided near the intersection by road-to-vehicle communication, information received from a vehicle traveling in front by vehicle-to-vehicle communication, or the like.

For example, when congestion or traffic regulation occurs in the first recommended route (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

When it is determined that congestion does not occur or there is no traffic regulation (Step S211: YES), information relating to the first recommended route is output (Step S203). That is, when congestion does not occur or there is no traffic regulation, there is a high possibility that the host vehicle can arrive at the destination smoothly when traveling on the first recommended route. When the prediction error range of the first recommended route includes lateness of the arrival time due to the traffic situation as an error in advance, the prediction error range is reduced. For this reason, since there is a relatively increasing advantage in guiding the first recommended route, the output of information relating to the second recommended route is limited.

As described above, according to the movement guidance device and the movement guidance method of this embodiment, the effects of (1) to (6) are obtained, and the following effects are also obtained.

(9) The traffic situation, such as the presence/absence of congestion or the presence/absence of traffic regulation, which is a parameter relating to the traveling environment factor is used when calculating the prediction error range of the first recommended route. For this reason, the provision of information conforming to the situation of the traveling environment around the host vehicle is performed at a point where the first recommended route and the second recommended route are branched.

### Fifth Embodiment

Next, a fifth embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, information (parameter) relating to the presence/absence of on-street parking and the presence/absence of traveling of an emergency vehicle which is the traveling environment factor is used as information for determining the presence/absence of change in the prediction error range of the first recommended route.

Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the presence/absence of on-street parking and the presence/absence of traveling of an emergency vehicle based on collective intelligence data registered in the database of the predicted value output unit 130.

When it is determined that the prediction error range of the first recommended route, that is, the arrival time to the destination has no correlation with the presence/absence of on-street parking and the presence/absence of traveling of an emergency vehicle (Step S210: NO), information relating to the first recommended route and the second recommended route is output (Step S204).

In Step S210, when it is determined that the prediction error range of the first recommended route has correlation with the presence/absence of on-street parking and the presence/absence of traveling of an emergency vehicle (Step S210: YES), determination is performed about whether or not the degree of coincidence of an item matching the user's request relating to the arrival time to the destination among the parameters, such as the presence/absence of on-street parking and the presence/absence of an emergency vehicle, and a current situation is high (Step S211). That is, determination is performed about whether or not there is on-street parking or an emergency vehicle in front of the traveling direction of the host vehicle on the first recommended route. The presence/absence of on-street parking or an emergency vehicle is determined based on information received from the center or information obtained by vehicle-to-vehicle communication, road-to-vehicle communication, or the like.

In Step S211, if it is determined that there is on-street parking or an emergency vehicle in front of the host vehicle (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

When it is determined that there is no on-street parking or emergency vehicle (Step S211: YES), information relating to the first recommended route is output (Step S203). That is, when there is no on-street parking or there is no emergency vehicle, there is a high possibility that the vehicle can arrive at the destination smoothly when traveling on the first recommended route. When the prediction error range of the first recommended route includes lateness of the arrival time due to on-street parking or an emergency vehicle as an error in advance, the prediction error range is reduced. Accordingly, since there is a relatively increasing advantage in guiding the first recommended route, the output of information relating to the second recommended route is limited.

As described above, according to the movement guidance device and the movement guidance method of this embodiment, the effects of (1) to (6) are obtained, and the following effects are also obtained.

(10) The parameter of the traffic situation, such as the presence/absence of on-street parking or the presence/absence of an emergency vehicle which is a parameter relating to the traveling environment factors is used when calculating the prediction error range of the first recommended route. For this reason, the provision of information conforming to the situation of the traveling environment around the host vehicle is performed at a point where the first recommended route and the second recommended route are branched.

### Sixth Embodiment

Next, a sixth embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, a waiting time of crossing (crossing gate) which is one of the traveling environment factors is used as information (parameter) for determining the presence/absence of change in the prediction error range of the first recommended route. Out of crossing, only crossing where congestion is likely to occur may be set as a target.

Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the waiting time of crossing based on collective intelligence data registered in the database of the predicted value output unit 130.

If it is determined that the prediction error range of the first recommended route, that is, the arrival time to the destination has no correlation with the waiting time of crossing (Step S210: NO), information relating to the first recommended route and the second recommended route is output (Step S204).

In Step S210, if it is determined that the arrival time of the first recommended route has correlation with the waiting time of crossing (Step S210: YES), determination is performed about whether or not the degree of coincidence of an item matching the user's request relating to the arrival time to the destination among the parameters relating to the waiting time of crossing and a current situation is high (Step S211). That is, determination is performed about whether or not the waiting time of crossing in front of the traveling direction of the host vehicle on the first recommended route is short. In this embodiment, the length of the waiting time of crossing is acquired in real time, and is information received from the center or information obtained by vehicle-to-vehicle communication, road-to-vehicle communication, or the like.

If it is determined that many vehicles wait for passing of crossing during crossing in front of the host vehicle in the first recommended route, and the waiting time of crossing at this time is long (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

When it is determined that the waiting time of crossing is short, for example, when congestion does not occur due to crossing (Step S211: YES), information relating to the first recommended route is output (Step S203). That is, when the waiting time of crossing is small, there is a high possibility that the vehicle can arrive at the destination smoothly. When the prediction error range of the first recommended route includes lateness of the arrival time due to the waiting time of crossing as an error in advance, the prediction error range is reduced. For this reason, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(11) Information relating to the waiting time of crossing which is a parameter relating to the traveling environment factor is used when calculating the prediction error range of the first recommended route. For this reason, the provision of information conforming to the situation of the traveling environment around the host vehicle is performed at a point where the first recommended route and the second recommended route are branched.

### Seventh Embodiment

Next, a seventh embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, a time segment is used as information (parameter) for determining the presence/absence of change in the prediction error range of the first recommended route. The time segment is one of time zone, day of week, and season. For example, on a highway of a rush hour zone, congestion tends to occur. On a road around a store having a large number of customers on Saturday or Sunday, congestion occurs on Saturday or Sunday. On a road around a resort, or the like, congestion occurs in a season suitable for the resort.

Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the time segment based on collective intelligence data registered in the database of the predicted value output unit 130.

When it is determined that the prediction error range of the first recommended route, that is, the arrival time to the destination has no correlation with the time segment (Step S210: NO), the second recommended route does not reach a reference for the guidance to the user, and information relating to the first recommended route and the second recommended route is output (Step S204).

In Step S210, if it is determined that the arrival time of the first recommended route corresponds to the time segment (Step S210: YES), determination is performed about whether or not the degree of coincidence of an item matching the user's request relating to the arrival time to the destination among the parameters of the time segment and a current situation is high (Step S211). That is, determination is performed about whether or not an item representing a time segment where the vehicle can travel smoothly matches a time segment at a point where the first recommended route and the second recommended route are branched or a point near this point by a predetermined distance.

In Step S211, if it is determined that the degree of coincidence of a time segment where there is a tendency to arrive at the destination early with a time segment at this time is low (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

When it is determined that the degree of coincidence of the time segment where there is a tendency to arrive at the destination early with the time segment at this time is high (Step S211: YES), information relating to the first recommended route is output (Step S203). That is, there is a high possibility that the vehicle can arrive at the destination smoothly in the time zone, on day of week, or in the season at this time. When the prediction error range of the first recommended route includes lateness of the arrival time due to the time segment as an error in advance, the prediction error range is reduced. Accordingly, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(12) The time segment, such as the time zone, day of week, and season, which is a parameter relating to the traveling environment factors is used when calculating the prediction error range of the first recommended route. For this reason, the provision of information conforming to the time segment which passes through a point where the first recommended route and the second recommended route are branched or a point near this point by a predetermined distance is performed.

### Eighth Embodiment

Next, an eighth embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, the presence/absence of an event along the first recommended route which is one of the traveling environment factors is used as information (parameter) for determining the presence/absence of change in the prediction error range of the first recommended route.

Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with the presence/absence of an event along the first recommended route based on collective intelligence data registered in the database of the predicted value output unit 130.

When it is determined that the prediction error range of the first recommended route, that is, the arrival time to the destination has no correlation with the presence/absence of an event in the first recommended route (Step S210: NO), information relating to the first recommended route and the second recommended route is output (Step S204).

In Step S210, if it is determined that the arrival time of the first recommended route has correlation with the presence/absence of an event along the first recommended route (Step S210: YES), determination is performed about whether or not the degree of coincidence of an item matching the user's request relating to the arrival time to the destination among the parameters relating to holding of an event and a current situation is high (Step S211). That is, determination is performed about whether or not there is no event to be held in front of the host vehicle along the first recommended route. At this time, a predicted time when the host vehicle passes through a place where an event is held may be compared with the holding time of the event. The presence/absence of an event to be held is determined based on information received from the center or information obtained by vehicle-to-vehicle communication, road-to-vehicle communication, or the like.

In Step S211, if it is determined that an event along the first recommended route is held (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

When it is determined that there is no event to be held along the first recommended route (Step S211: YES), information relating to the first recommended route is output (Step S203). That is, when there is no event to be held along the first recommended route, there is a high possibility that the vehicle can arrive at the destination smoothly. When the prediction error range of the first recommended route includes lateness of the arrival time due to congestion caused by holding an event as an error in advance, the prediction error range is reduced. For this reason, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(13) Information relating to the presence/absence of an event to be held along the first recommended route which is a parameter relating to the traveling environment factors is used when calculating the prediction error range of the first recommended route. For this reason, the provision of information conforming to the situation of an environment along the first recommended route is performed.

### Ninth Embodiment

Next, a ninth embodiment of a movement guidance device and a movement guidance method according to the invention will be described referring to FIG. 13 used in the third embodiment focusing on a difference from the first embodiment. The movement guidance device and the movement guidance method of this embodiment have the same basic configuration as in the first embodiment. In FIG. 13, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, weather which is one of the traveling environment factors is used as information (parameter) for determining the presence/absence of change in the prediction error range of the first recommended route. Referring to FIG. 13, the output control processing (Step S104 in FIG. 6) when the relationship between the prediction error range of the first recommended route and the prediction error range of the second recommended route corresponds to the pattern 2 will be described. In Step S210, determination is performed about whether or not the prediction error range of the first recommended route has correlation with weather when traveling on the first recommended route based on collective intelligence data registered in the database of the predicted value output unit 130.

When it is determined that the prediction error range of the first recommended route, that is, the arrival time to the destination has no correlation with weather (Step S210: NO), information relating to the first recommended route and the second recommended route is output (Step S204).

In Step S210, if it is determined that the arrival time of the first recommended route has correlation with weather (Step S210: YES), determination is performed about whether or not the degree of coincidence of an item matching the user's request relating to the arrival time to the destination among the parameters relating to weather and a current situation is high (Step S211). That is, for example, determination is performed about whether or not weather “fine” which allows traveling on the first recommended route smoothly matches weather when the host vehicle approaches a point where the first recommended route and the second recommended route are branched. Weather information is determined based information received from the center, information obtained by vehicle-to-vehicle communication, road-to-vehicle communication, or the like, a raindrop detection sensor provided in the host vehicle, or the like.

In Step S211, for example, if it is determined that the current weather near a point whether the first recommended route and the second recommended route are branched is “rain” or “snow” (Step S211: NO), the prediction error range of the first recommended route changes, and there is a tendency that the arrival time becomes late. Accordingly, since there is a relatively increasing advantage in guiding the second recommended route, information relating to the first recommended route and the second recommended route is output (Step S204).

For example, if it is determined that the current weather near the point where the first recommended route and the second recommended route are branched is “fine” (Step S211: YES), information relating to the first recommended route is output (Step S203). That is, when the current weather near the point where the first recommended route and the second recommended route are branched is weather which does not obstruct smooth traveling on the first recommended route, there is a high possibility that the host vehicle can arrive at the destination smoothly. When the prediction error range of the first recommended route includes lateness of the arrival time due to weather as an error in advance, the prediction error range is reduced. For this reason, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(14) Information relating to weather when another vehicle travels on the first recommended route which is a parameter relating to the traveling environment factors is used when calculating the prediction error range of the first recommended route. For this reason, the provision of information conforming to an environment along the first recommended route is performed.

### Tenth Embodiment

Next, a tenth embodiment of a movement guidance device and a movement guidance method according to the invention will be described referring to FIG. 15 focusing on a difference from the first embodiment. The movement guidance device and the movement guidance method of this embodiment have the same basic configuration as in the first embodiment. In FIG. 15, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, a parameter relating to the vehicle factors is used as information for determining the presence/absence of change in the prediction error range of the first recommended route. Information relating to the host vehicle is registered in the information terminal 100 or the center in advance.

Referring to FIG. 15, the output control processing (Step S104 in FIG. 6) when the relationship between the prediction error range of the first recommended route and the prediction error range of the second recommended route corresponds to the pattern 2 will be described. In Step S212, determination is performed about whether or not the prediction error range of the first recommended route has correlation with the vehicle factors based on collective intelligence data registered in the database of the predicted value output unit 130.

For example, the vehicle type may be used as the parameter relating to the vehicle factors. In the distribution of collective intelligence data, for example, in case of a compact car, there is a tendency that the arrival time to the destination in the first recommended route becomes early, and in case of a heavy vehicle, there is a tendency that the arrival time becomes late.

The type of tire may be used as the parameter relating to the vehicle factors. In the distribution of collective intelligence data, for example, when an off-road tire is mounted, there is a tendency that the arrival time to the destination in the first recommended route becomes early, and when a tire for normal traveling is mounted, there is a tendency that the arrival time becomes late.

Information regarding whether or not a vehicle is a towing vehicle may be used as a parameter relating to the vehicle factors. In the distribution of collective intelligence data, for example, when a vehicle is not a towing vehicle, there is a tendency that the arrival time to the destination on the first recommended route becomes early, and when a vehicle is a towing vehicle, there is a tendency that the arrival time becomes late.

In Step S212, when it is determined that the arrival time of the first recommended route has no correlation with the parameter relating to the vehicle factors (Step S212: NO), information relating to the first recommended route and the second recommended route is output (Step S204).

If it is determined that the arrival time of the first recommended route has correlation with the parameter relating to the vehicle factors (Step S212: YES), determination is performed about whether or not the degree of coincidence of an item matching the user's request relating to the arrival time to the destination among the parameters relating to the vehicle factors and a current situation is high (Step S213). For example, when an item having a tendency to arrive at the destination early is “compact car”, determination is performed about whether or not the vehicle type of the host vehicle matches “compact car”. When an item having a tendency to arrive at the destination early is “off-road tire”, determination is performed about whether or not the tire of the host vehicle matches “off-road tire”. When an item having a tendency to arrive at the destination early is “no towing”, determination is performed about whether or not the host vehicle matches “no towing”.

In Step S213, if it is determined that the degree of coincidence of the item matching the user's request and the host vehicle is low (Step S213: NO), there is a tendency that the arrival time of the first recommended route becomes late. Accordingly, there is a relatively increasing advantage in guiding the second recommended route. For this reason, information relating to the first recommended route and the second recommended route is output (Step S204).

If it is determined that the degree of coincidence of the item matching the user's request and the vehicle factor of the host vehicle is high (Step S213: YES), information relating to the first recommended route is output (Step S203). That is, for example, when the vehicle type of the host vehicle is “compact car”, there is a high possibility that the host vehicle can arrive at the destination smoothly when traveling on the first recommended route. When the tire of the host vehicle is “off-road tire”, there is a high possibility that the host vehicle can arrive at the destination smoothly when traveling on the first recommended route. When the host vehicle is “no towing”, there is a high possibility that the host vehicle can arrive at the destination smoothly when traveling on the first recommended route. For this reason, when the prediction error range of the first recommended route includes lateness of the arrival time by the vehicle factor as an error in advance, the prediction error range is reduced. For this reason, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(15) The parameter relating to the vehicle factors is used when calculating the prediction error range of the first recommended route. For this reason, the provision of information conforming to the situation of the host vehicle is performed at a point where the first recommended route and the second recommended route are branched.

### Eleventh Embodiment

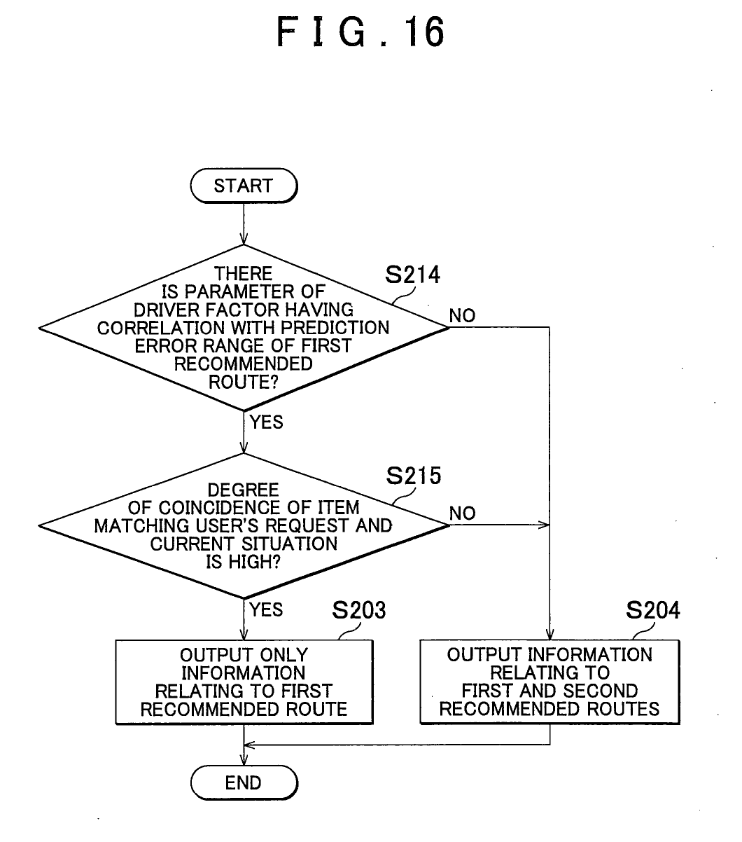

Next, an eleventh embodiment of a movement guidance device and a movement guidance method according to the invention will be described referring to FIG. 16 focusing on a difference from the first embodiment. The movement guidance device and the movement guidance method of this embodiment have the same basic configuration as in the first embodiment. In FIG. 16, the substantially same elements as those in the first embodiment are represented by the same reference numerals, and overlapping description will be omitted.

In this embodiment, it is assumed that the user's request relating to the arrival time or the movement time to the destination is “arrival as early as possible”. It is assumed that the information terminal 100 guides only the predicted arrival time out of the predicted arrival time and the predicted movement time.

In this embodiment, a parameter relating to the driver factors is used as information for determining the presence/absence of change in the prediction error range of the first recommended route. Referring to FIG. 16, the output control processing (Step S104 in FIG. 6) when the relationship between the prediction error range of the first recommended route and the prediction error range of the second recommended route corresponds to the pattern 2 will be described. In Step S214, determination is performed about whether or not the prediction error range of the first recommended route has correlation with the driver factor based on collective intelligence data registered in the database of the predicted value output unit 130. Information relating to the driver of the host vehicle is registered in the information terminal 100 or the center in advance.

For example, a driving skill may be used as a parameter relating to the drive factors. In the distribution of collective intelligence data, for example, when the driving skill is “high”, there is a tendency that the arrival time to the destination in the first recommended route becomes early, and when the driving skill is “low”, there is a tendency that the arrival time becomes late.

A traveling frequency may be used as a parameter relating to the driver factors. In the distribution of collective intelligence data, for example, when the traveling frequency of the first recommended route is “high”, there is a tendency that the arrival time to the destination in the first recommended route becomes early, and when the traveling frequency is “low”, there is a tendency that the arrival time becomes late.

A place of birth or a place of residence of a driver may be used as a parameter relating to the driver factors. In the distribution of collective intelligence data, for example, when the first recommended route includes the place of birth or the place of residence of the driver, there is a tendency that the arrival time to the destination in the first recommended route becomes early, and when the first recommended route does not include the place of birth or the place of residence of the driver, there is a tendency that the arrival time becomes late.

An age of a driver may be used as a parameter relating to the driver factors. In the distribution of collective intelligence data, for example, when the age of the driver is “middle”, there is a tendency that the arrival time to the destination in the first recommended route becomes early, and when the age of the driver is “old”, there is a tendency that the arrival time becomes late.

In Step S214, when it is determined that the arrival time of the first recommended route has no correlation with the parameter relating to the driver factors (Step S214: NO), information relating to the first recommended route and the second recommended route is output (Step S204).

If it is determined that the arrival time of the first recommended route has correlation with the parameter relating to the driver factors (Step S214: YES), determination is performed about whether or not the degree of coincidence of an item matching the user's request relating to the arrival time to the destination among the parameters relating to the driver factors and a current situation is high (Step S215). For example, when an item having a tendency to arrive at the destination early is “driving skill; high”, determination is performed about whether or not the driving skill of the driver of the host vehicle is “high”. When an item having a tendency to arrive at the destination early is “traveling frequency: high”, determination is performed about whether or not the traveling frequency of the driver of the host vehicle in the first recommended route is “high”. When an item having a tendency to arrive at the destination early is “the first recommended route includes the place of birth or place of residence of the driver”, determination is performed about whether or not the first recommended route includes the place of birth or the place of residence of the driver. When an item having a tendency to arrive at the destination early is “age: middle”, determination is performed about whether or not the age of the driver of the host vehicle is “middle”.

In Step S215, determination is performed about whether or not the degree of coincidence of an item matching the user's request relating to the arrival time to the destination and the parameter of the driver of the host vehicle is low (Step S215: NO), there is a tendency that the arrival time of the first recommended route becomes late. Accordingly, there is a relatively increasing advantage in guiding the second recommended route. For this reason, information relating to the first recommended route and the second recommended route is output (Step S204).

In Step S215, if it is determined that the degree of coincidence of the item matching the user's request and the parameter of the driver of the host vehicle is high (Step S215: YES), information relating to the first recommended route is output (Step S203). That is, for example, when the driver of the host vehicle is “driving skill: high”, there is a high possibility that the host vehicle can arrive at the destination smoothly when traveling on the first recommended route. When the driver of the host vehicle is “traveling frequency: high” for the first recommended route, there is a high possibility that the host vehicle can arrive at the destination smoothly when traveling on the first recommended route. When “the place of birth or the place of residence” of the driver of the host vehicle is included in the first recommended route, there is a high possibility that the host vehicle can arrive at the destination smoothly when traveling on the first recommended route. When the driver of the host vehicle is “age: middle”, there is a high possibility that the host vehicle can arrive at the destination smoothly when traveling on the first recommended route. When the prediction error range of the first recommended route includes lateness of the arrival time by the driver factors as an error in advance, the prediction error range is reduced. For this reason, since there is a relatively increasing advantage in guiding the first recommended route, the output of information relating to the second recommended route is inhibited.

As described above, according to the movement guidance device and the movement guidance method of this embodiment, the effects of (1) to (6) are obtained, and the following effects are also obtained.

(16) The driver factor of the host vehicle is used when calculating the prediction error range of the first recommended route. For this reason, the provision of information conforming to the situation of the host vehicle is performed at a point where the first recommended route and the second recommended route are branched.

### Other Embodiments

The respective embodiments may be carried out in the following forms. In the first embodiment, although, when the prediction error range of the first recommended route is recalculated, and as a result, the prediction error range changes, the prediction error range of the first recommended route is output in the changed state, the prediction error range may be output unchanged such that the width thereof is maintained. That is, in the first embodiment, since the recalculation of the prediction error range of the first recommended route is focused on the determination of the permission/inhibition of the output of information relating to the second recommended route, even if the prediction error range changes, it is not necessary to output the prediction error range in the changed state.

In the respective embodiments, although the first recommended route is a route which is searched based on the destination and the search condition set by the user, the search condition may not be set by the user, and a condition set in the movement guidance device in advance, a condition optimized or selected by the movement guidance device, or the like may be used. The first recommended route may be a route which is selected from among the routes searched on different conditions, such as time preference, distance preference, cost preference, and road type preference by evaluating a plurality of items of time, distance, cost, and the like in a comprehensive manner.

In the respective embodiments, although the predicted value output unit 130 estimates the user's request, the user's request may be input to the predicted value output unit 130 based on an operation of the user of the input unit 103.

In the above-described second embodiment, when there is no collective intelligence data having a high degree of coincidence with the user, the output of information relating to the second recommended route may be limited. In the above-described second embodiment, when the calculation of the prediction error range is performed based on the movement patterns (collective intelligence data) of a plurality of mobile objects, and when the divergence between the movement pattern used in the calculation and the movement pattern of the mobile object to be an output target of the prediction error range is equal to or greater than a predetermined value, the predicted value output unit 130 may limit the output of the prediction error range for which it is determined that the divergence is equal to or greater than the predetermined value. With this, when the calculation of the prediction error range is performed based on the movement patterns of a plurality of mobile objects, and when the divergence between the movement pattern used for the calculation and the movement pattern of the mobile object to be the output target of the prediction error range is equal to or greater than the predetermined value, the output of the prediction error range for which it is determined that the divergence is equal to or greater than the predetermined value is limited. That is, when the movement patterns of a plurality of mobile objects used as so-called collective intelligence do not conform the characteristic of the user, for example, the movement time, the arrival time, and the prediction error ranges of the movement time and the arrival time calculated based on collective intelligence are highly likely to be different from the movement time or the arrival time by the user. However, with this, when the divergence between the movement pattern used for the calculation and the movement pattern of the mobile object to be the output target of the prediction error range is equal to or greater than the predetermined value, the output of the prediction error range for which it is determined that the divergence is equal to or greater than the predetermined value is limited, whereby information generated based on elements not conforming to the characteristic of the user is limited. In other words, only information generated based on elements conforming to the characteristic of the user is provided to the user.

In the second embodiment, although the collective intelligence analysis and the personal adaptation analysis are performed on the prediction error range of the second recommended route, and are then performed on the prediction error range of the first recommended route, the collective intelligence analysis and the personal adaptation analysis may be performed only on the second recommended route, or may be performed only on the first recommended route. Although the collective intelligence analysis and the personal adaptation analysis are performed on the prediction error range of the first recommended route only in the pattern 2, the collective intelligence analysis and the personal adaptation analysis may be performed on the prediction error range of the first recommended route in other patterns. Alternatively, the collective intelligence analysis and the personal adaptation analysis may be performed on the prediction error range of the first recommended route without determining the patterns. When the prediction error range of the second recommended route is recalculated, and as a result, the width of the prediction error range changes, the changed prediction error range may be output to at least one of the display device 220 or the sound device 210 on the condition that the prediction error range is smaller than the prediction error range of the first recommended route. When the prediction error range of the second recommended route changes, the prediction error range of the second recommended route may be output on the condition of matching the estimated user's request.

In the second embodiment, the same analysis as the prediction error range of the first recommended route may be performed on the prediction error range of the second recommended route. In the third to eleventh embodiments, although the permission/inhibition of information relating to the second recommended route is determined based on one of the parameters of the respective embodiments, as in the second embodiment, the degree of coincidence with the user's request may be determined in a comprehensive manner using a plurality of parameters among the parameters of the third to eleventh embodiments.

In the third to eleventh embodiments, although the user's request relating to the arrival time to the destination is “arrival as early as possible”, the user's request may be “arrival as late as possible” or may be “arrival neither early nor late”. When the user's request is “arrival neither early nor late”, and when the relationship between the prediction error ranges corresponds to the pattern 2, information relating to the first and second recommended routes may be output without comparing correlated information (collective intelligence data) with personal data.

In the respective embodiments, although the second calculation unit 120 newly acquires traffic information each time the vehicle reaches near an intersection or a junction by a predetermined distance and searches a route from the present place of the vehicle to the destination based on the acquired traffic information or the like on a condition different from the first recommended route, a route may be searched at other timings. For example, the second calculation unit 120 may search for a route on a condition different from the first calculation unit 110 at a departure place for which a destination is set and may store information relating to the route.

In the respective embodiments, although the user's request is classified into three of “arrival as early as possible”, “arrival neither too early too late”, and “arrival as late as possible”, the user's request may be “arrival as early as possible”. For example, the user's request may be classified into two of “arrival as early as possible” and “arrival as late as possible”. The user's request may be classified into a plurality of three or more patterns including, for example, “early arrival within 30 minutes with respect to the desired arrival time”, “arrival within 10 minutes before and after the desired arrival time”, and the like. In this case, for example, when the prediction error range of the second recommended route is included in the prediction error range of the first recommended route, the permission/inhibition of the output of information relating to the second recommended route described above may be determined based on the degree of coincidence with the user's request.

In the respective embodiments, when it is determined that there is no information having correlation with the prediction error range of the first recommended route (for example, Step S201 of FIG. 7: NO), information relating to the first recommended route and the second recommended route is output. Alternatively, when it is determined that there is no information having correlation with the prediction error range of the first recommended route, only information relating to the first recommended route may be output. In this case, the amount of information to be provided to the user is reduced, whereby there is an increasing advantage for a user who is likely to feel unease due to a large amount of information.

In the respective embodiments, when the prediction error range of the first recommended route and the prediction error range of the second recommended route correspond to the pattern 2, and when the user's request relating to the arrival time is “arrival neither too early nor too late”, information relating to the second recommended route is output. As another aspect, when the relationship between the prediction error ranges corresponds to the pattern 2, and when the user's request relating to the arrival time is “arrival neither too early nor too late”, information relating to the second recommended route may be output when a predetermined condition other than the user's request relating to the arrival time is established. As the predetermined condition, for example, the movement distance of the entire route, cost (fee) required for passing the route, the amount of fuel consumption required for traveling the route, or a user's request other than the request relating to the arrival time may be used.

In the respective embodiments, the prediction error range of the first recommended route may be recalculated at a point where the first recommended route and the second recommended route are branched, and the permission/inhibition of the output of the prediction error range of the second recommended route may be determined based on whether or not the prediction error range of the second recommended route is smaller than the recalculated prediction error range of the first recommended route.

In the respective embodiments, when the prediction error range of the first recommended route or the prediction error range of the second recommended route is calculated but is disadvantageous with respect to the desired arrival time of the user, the guidance of the recommended route may not be performed. When the calculated prediction error range is disadvantageous with respect to the desired arrival time of the user, the output of the prediction error range of the recommended route may not be performed. When it is disadvantageous with respect to the desired arrival time of the user, this refers to that the latest time of the prediction error range becomes later than the desired arrival time, the earliest time of the prediction error range becomes later than the desired arrival time, or the difference is equal to or less than a preset time.

In the respective embodiments, the first calculation unit 110 or the second calculation unit 120 may calculate the prediction error range based on the movement history of the host vehicle to be an output target of the prediction error range. In this case, the host vehicle accumulates information of the traveled route in a database in association with the movement time.

In the respective embodiments, when the prediction error range calculated by the second calculation unit 120 is smaller than the prediction error range calculated by the first calculation unit 110, output for performing the output of at least one of the prediction error range of the second predicted arrival time and the prediction error range of the second predicted movement time calculated by the second calculation unit 120 may be performed. Through the output control for example, when precision of information relating to the second recommended route is relatively high, information relating to the second recommended route as further guidance different from the first recommended route is output. Accordingly, the necessity of the output of information relating to the first recommended route with relatively low precision is lowered due to the presence of information relating to the second recommended route, and the output of information relating to the first recommended route is not performed. With this, it becomes possible for the user to easily confirm information with relatively high precision.

In the respective embodiments, although a route according to the user's request relating to the arrival time to the destination is guided, the permission/inhibition of route guidance may be determined based on the degree of coincidence with other user's requests. For example, the guidance of a route in which fuel may not be replenished, a route according to the preference of the user, or the like may be intended.

In the respective embodiments, although, when the relationship between the prediction error range of the first recommended route and the prediction error range of the second recommended route corresponds to the pattern 2, the prediction error range of the first recommended route is calculated, when the relationship corresponds to the pattern 1 or 3, the prediction error range of the first recommended route may be calculated. When the prediction error range of the first recommended route changes, the prediction error range may be displayed on the display screen of the display device 220 in the changed state.

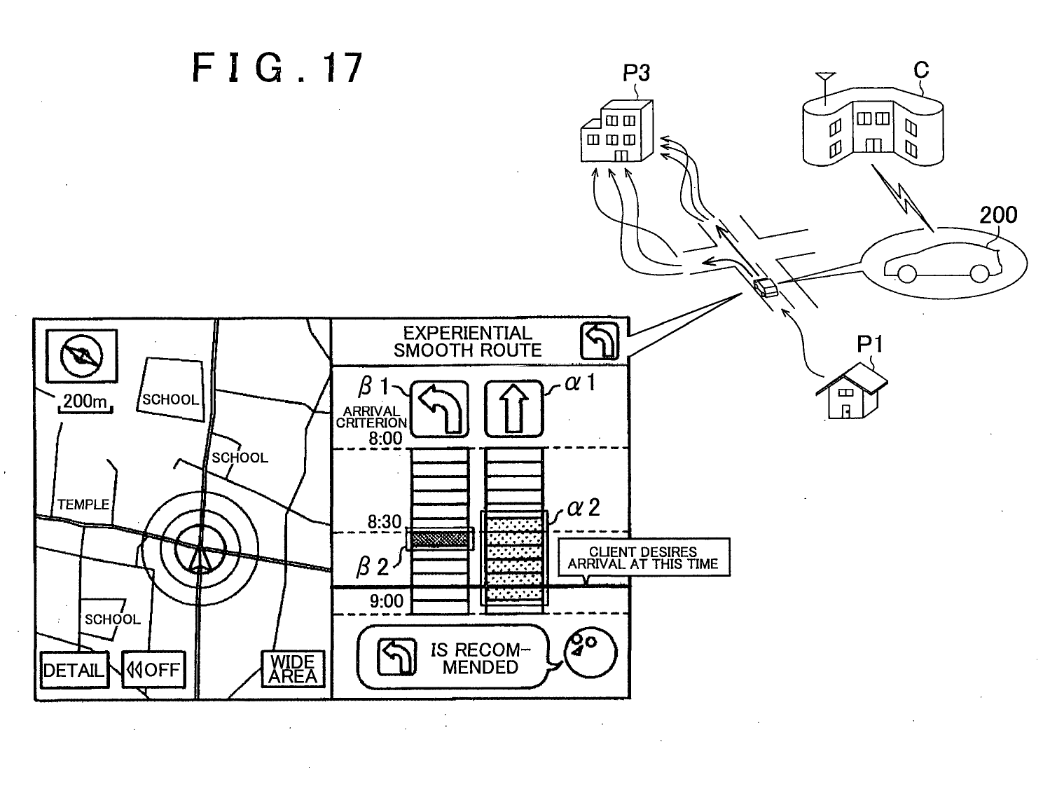

In the respective embodiments, as shown in FIG. 17, at least one of the first calculation unit 110, the second calculation unit 120, or the predicted value output unit 130 of the information terminal 100 may be provided in a center C which can communication with the information terminal 100 or the vehicle 200. For example, in this case, the position of the departure place P1 and the position of the destination P3 are transmitted from the information terminal 100. With this, information terminal 100 may only display information calculated in the center C or information for which the permission/inhibition of the output is determined, whereby reduction in processing load is achieved.

In the respective embodiments, the output of information relating to each of the first and second recommended routes may be performed only by sound or only by an image. In the respective embodiments, a mobile object may be the user who uses the information terminal 100, not a vehicle. With this, the guidance is possible during walking of the user or during movement using a bicycle.

In the respective embodiments, information relating to the recommended route and the prediction error range of the predicted arrival time is primarily output and guided to the user. The invention is not limited thereto, and information relating to the recommended route and the prediction error range of the predicted movement time may be output and guided to the user. Similarly, information relating to three of the recommended route, the prediction error range of the predicted arrival time, and the prediction error range of the predicted movement time may be output and guided to the user. Furthermore, the guidance of the recommended route may not be output, and at least one of the prediction error range of the predicted arrival time or the prediction error range of the predicted movement time may be output.

In the respective embodiments, the second recommended route may include two or more routes. Then, the guidance of the route and the output of the prediction error range may be performed for each of the two or more second recommended routes.

1. A movement guidance device that informs at least one of predicted arrival time information at which a mobile object arrives at a destination or predicted movement time information necessary until the mobile object arrives at the destination, the movement guidance device comprising:
a first calculation unit that calculates at least one of a prediction error range of a predicted arrival time or a prediction error range of a predicted movement time in a first route to the destination;
a second calculation unit that calculates at least one of a prediction error range of a predicted arrival time or a prediction error range of a predicted movement time in a second route, that is a route to the destination and is different from the first route, at a point where the first route and the second route are branched; and
a predicted value output unit that outputs at least one of the prediction error range of the first route or the prediction error range of the second route,
wherein at least one of the first calculation unit or the second calculation unit calculates a prediction error range based on information having correlation with the prediction error range at the point where the first route and the second route are branched, and
the predicted value output unit performs determination about an aspect of output of the prediction error range of the first route and the prediction error range of the second route based on whether or not the calculated prediction error range changes with respect to a reference prediction error range.

2. The movement guidance device according to claim 1,
wherein the predicted value output unit performs determination about whether or not the prediction error range of the first route changes based on information having correlation with the prediction error range of the first route when the prediction error range of the second route is smaller than the prediction error range of the first route and limits the output of information relating to the second route based on a degree of coincidence with a user's request estimated as a change direction of the prediction error range when the prediction error range of the first route changes.

3. The movement guidance device according to claim 1,
wherein, after outputting the prediction error range of the first route in a first range, the predicted value output unit acquires information capable of reducing the prediction error range as information having correlation with the prediction error range of the first route at the point where the first route and the second route are branched, and when the prediction error range is reduced, outputs a prediction error range reduced smaller than the first range to an output device.

4. The movement guidance device according to claim 1,
wherein the predicted value output unit acquires collective intelligence data, in which the movement histories of a plurality of mobile objects are registered by feature quantity, as information having correlation with the prediction error range, evaluates the degree of coincidence with a situation when outputting the collective intelligence data and the prediction error range, and performs determination about whether or not the prediction error range changes based on the evaluated degree of coincidence.

5. The movement guidance device according to claim 4,
wherein, when the calculation of the prediction error range is performed based on the movement patterns of a plurality of kinds of mobile objects, and when the divergence between the movement pattern used for the calculation and the movement pattern of a mobile object to be an output target of a prediction error range is equal to or greater than a predetermined value, the predicted value output unit limits the output of a prediction error range for which it is determined that the divergence is equal to or greater than the predetermined value.

6. The movement guidance device according to claim 4,
wherein the predicted value output unit evaluates the degree of coincidence of the collective intelligence data and a current situation to be an output target of the prediction error range for at least one of a factor relating to the mobile object, a factor relating to the user of the mobile object, or a factor relating to the movement environment of the mobile object.

7. The movement guidance device according to claim 1,
wherein a predetermined point for use in the calculation of the prediction error range is in terms of intersections or junctions, and the predicted value output unit performs the output of the prediction error range each time the mobile object reaches near the predetermined point by a predetermined distance.

8. The movement guidance device according to claim 1,
wherein, when there are the first route set as a route to a destination and the second route different from the first route, the predicted value output unit performs, as a prediction error range of the first route and a prediction error range of the second route, one of controls: a: control for performing “no” output when all prediction error ranges are equal to or greater than a preset range, b: control for performing the output of only the prediction error range of the first route when the prediction error range calculated for the first route is smaller than the prediction error range calculated for the second route, c: control for performing the output of only the prediction error range of the second route when the prediction error range calculated for the second route is smaller than the prediction error range calculated for the first route, and d: control for simultaneously performing the output of the prediction error range of the first route and the prediction error range of the second route when the prediction error range calculated for the second route is smaller than the prediction error range calculated for the first route.

9. The movement guidance device according to claim 1,
wherein, when the latest predicted arrival time out of the prediction error range of the predicted arrival time is later than an arrival time intended by the user, the output relating to a route having the prediction error range is inhibited.

10. A movement guidance method that informs at least one of predicted arrival time information at which a mobile object arrives at a destination or predicted movement time information necessary until the mobile object arrives at the destination, the movement guidance method comprising:
calculating at least one of a prediction error range of a predicted arrival time or a prediction error range of a predicted movement time in a first route to the destination;
calculating at least one of a prediction error range of a predicted arrival time or a prediction error range of a predicted movement time in a second route, which is a route to the destination and is different from the first route, at a point where the first route and the second route are branched; and
acquiring information having correlation with at least one of the prediction error range of the first route or the prediction error range of the second route at the point where the first route and the second route are branched and performing determination about the aspect of output of the prediction error range of the first route and the prediction error range of the second route based on whether or not the prediction error range changes based on the correlated information.
